(19) United States
(12) Patent Application Publication
(10) Pub. No.: US 2011/0051196 A1
(43) Pub. Date: Mar. 3, 2011

(54) PRINT CONTROL APPARATUS

(75) Inventors: Yuji Hatanaka, Shicjlri-shi (JP); Yoshihiko Matsuzawa, Matsumoto-shi (JP)

(73) Assignee: SEIKO EPSON CORPORATION, Shinjuku-ku (JP)

(21) Appl. No.: 12/875,051

(22) Filed: Sep. 2, 2010

(30) Foreign Application Priority Data
Sep. 3, 2009 (JP) 2009-203628
May 13, 2010 (JP) 2010-110854

(51) Int. Cl. G06K 15/00; G06F 15/00; H04N 1/60

(52) U.S. Cl. 358/2.1

(57) ABSTRACT

A print control apparatus is provided, which controls a printing apparatus that performs printing using a plurality of color inks including a white ink. The print control apparatus includes a toning white designation unit that designates a plurality of partial regions in a print region where the printing by the printing apparatus is performed, and designating at least one of sets of density values and color specification values with respect to a toning white that is defined by a combination of the density value and the color specification value in a predetermined color system with respect to the partial regions; and a print control unit that controls a first image forming unit that forms a color image on the print region and a second image forming unit that forms a toning white image on the partial regions in which the sets of the density values and the color specification values are designated.

Priority is claimed under 35 U.S.C §119 to Japanese Application No. 2009-203628 filed on Sep. 3, 2009, and No, 2010-110854 filed on May 13, 2010, which is hereby incorporated by reference in its entirety.

### BACKGROUND

1. Technical Field

The present invention relates to technology for performing printing using a plurality of color inks including a white ink.

2. Related Art

A printing apparatus which performs printing using a white ink in addition to color inks of cyan, magenta, and yellow has been known. In relation to the printing apparatus that performs printing using a plurality of color inks including the white ink, several methods for making it possible to perform color image printing that is not affected by a ground color of a print medium have been known. As one example, white dots are formed on a portion where color dots are not formed using a white ink (for example, see JP-A-2005-88520). As another example, a discharge amount of a white ink is changed in accordance with the transparency of a print medium when the ground of the print medium is processed using the white ink (for example, see JP-A-2005-262553).

In processing the ground of the print medium using the white ink as described above, the white color of the ground portion is determined by the color of the white ink. However, there has been a demand for setting the white color of the ground portion as a desired color, for example, to match a color image that is printed on a printing medium.

### SUMMARY

An advantage of some aspects of the invention is to make it possible to form a white image of a desired color together with a color image on a plurality of partial regions of a print region when printing is performed using a plurality of color inks including a white ink.

In order to solve at least a part of the above-mentioned problems, the invention can be realized by the following configuration or applications.

### Application 1

A print control apparatus which controls a printing apparatus that performs printing using a plurality of color inks including a white ink, which includes a toning white designation unit that designates a plurality of partial regions in a print region where the printing by the printing apparatus is performed, and designating at least one of sets of density values and color specification values with respect to a toning white that is defined by a combination of the density value and the color specification value in a predetermined color system with respect to the plurality of partial regions; and a print control unit that controls a first image forming unit that forms a color image on the print region and a second image forming unit that forms a toning white image on the partial regions in which the sets of the density values and the color specification values are designated.

According to this configuration, in the case of performing the printing using the plurality of color inks including the white ink, the plurality of partial regions are designated on the print region, and at least one of the sets of the density values and the color specification values of the toning white can be designated with respect to the plurality of partial regions. Accordingly, with respect to the plurality of partial regions on the print region, an image of the toning white (white image) of a desired color can be formed together with the color image.

### Application 2

The print control apparatus as described in Application 1 further includes an analysis unit which determines characteristic colors that characterize the color image based on image data that is data of the color image formed on the print region, and sets at least either of the density value and the color specification value based on the characteristic colors of the color image.

According to this configuration, the characteristic colors that characterize the color image are determined based on the image data that is the data of the color image formed on the print region, and the colors of the toning white image is determined based on the corresponding characteristic colors. Accordingly, for example, by combining colors of the toning white image and the color image, it becomes possible to perform printing using various color expressions.

### Application 3

In the print control apparatus as described in Application 2, the analysis unit further sets at least either of the density value and the color specification value so that the toning white becomes a complementary color of the characteristic color of the color image.

According to this configuration, since at least either the density value or the color specification value of the toning white is set so that the toning white image becomes the complementary color of the characteristic color of the color image, the toning white image, which has the color that becomes the complementary color of the characteristic color of the color image, is formed. Accordingly, for example, by combining the colors of the toning white image and the color image, it becomes possible to perform printing with an improved contrast ratio of the color image.

### Application 4

In the print control apparatus as described in Application 2 or 3, the analysis unit further determines the characteristic color of the color image based on a pixel value that is obtained by sampling the image data.

According to this configuration, the characteristic color of the color image is determined based on the pixel value which is obtained by sampling image data that is data of the color image. Accordingly, the characteristic color of the color image can be determined in a general-purpose method.

### Application 5

In the print control apparatus as described in Application 2 or 3, the analysis unit further determines the characteristic color of the color image by at least either the discrimination of a photographed scene of the image data or the extraction of a predetermined object included in the image data.

According to this configuration, the characteristic color of the color image is determined by at least either the discrimination of a photographed scene of the image data or the extraction of a predetermined object included in the image data. Accordingly, the characteristic color of the color image can be easily determined.

### Application 6

In the print control apparatus as described in any one of Applications 1 to 5, the print control unit further controls the first image forming unit and the second image forming unit so that the image forming by the first image forming unit and the image forming by the second image forming unit are simultaneously performed in at least a portion of a period of printing.

According to this configuration, since the image forming by the first image forming unit and the image forming by the second image forming unit are simultaneously performed in at least a portion of a period of printing, the printing process for forming a white image of a desired color together with a color image on a print medium can be efficiently performed.

### Application 7

In the print control apparatus as described in any one of Applications 1 to 6, the analysis unit further acquires the characteristic color of the print medium, and sets at least either the density value or the color specification value based on the characteristic color of the print medium.

According to this configuration, in the case of performing printing using a plurality of color inks including a white ink, the characteristic color that characterizes the print medium is acquired, and at least either the density value or the color specification value is set based on the characteristic color of the print medium. Accordingly, an image of a toning white (white image) of a color based on the color of the print medium can be formed on the print region.

The invention can be realized in diverse embodiments such as, for example, print control apparatus and method, printing apparatus and method, a printing system including the printing apparatus and the print control apparatus, computer programs for realizing functions of the above-mentioned methods, apparatuses, or systems, recording medium recorded with such computer programs, and the like.

### BRIEF DESCRIPTION OF THE DRAWINGS

The invention will be described with reference to the accompanying drawings, wherein like numbers reference like elements.

FIG. 1 is an explanatory view schematically illustrating the configuration of a printing system according to a first embodiment of the invention.

FIG. 2 is an explanatory view schematically illustrating the configuration of a PC.

FIG. 3 is an explanatory view schematically illustrating the configuration of a printer.

FIG. 4 is a block diagram functionally illustrating the configuration of a PC.

FIG. 5 is a block diagram functionally illustrating the configuration of a printer.

FIG. 6 is a flowchart illustrating a flow of processes in a printing system according to an embodiment of the invention.

FIGS. 7A to 7E are explanatory views illustrating examples of a print image, color image data, and white image data per region.

FIGS. 8A and 8B are explanatory views illustrating a printing order of a color image and a white image.

FIG. 9 is a flowchart illustrating a flow of a toning white designation process by an application program.

FIG. 10 is an explanatory view illustrating an example of a region designation window.

FIG. 11 is a flowchart illustrating a flow of a region toning white designation process by an application program.

FIGS. 12A and 12B are explanatory views illustrating an example of a toning white designation window.

FIG. 13 is a flowchart illustrating a flow of automatic toning white designation process by an application program.

FIG. 14 is an explanatory view illustrating a region designation window after an automatic toning white designation process is performed.

FIG. 15 is a flowchart illustrating a flow of processes by CPU that executes a printer driver.

FIG. 16 is a flowchart illustrating a flow of color conversion process ink color separation and halftone processes for a toning white image.

FIGS. 17A and 17B are explanatory views partially illustrating an example of a lookup table for a toning white image.

FIG. 18 is a flowchart illustrating a flow of color conversion process ink color separation and halftone processes for a color image.

FIG. 19 is an explanatory view partially illustrating an example of a lookup table for a color image.

FIG. 20 is a flowchart illustrating a flow of a command preparation process.

FIGS. 21A and 21B are explanatory views illustrating an example of a command prepared by a command preparation process.

FIG. 22 is an explanatory view illustrating an example of the contents of an ink code table.

FIG. 23 is a flowchart illustrating a flow of a process by a printer.

FIG. 24 is an explanatory view illustrating the detailed configuration of a raster buffer and a head buffer.

FIGS. 25A to 25C are explanatory views illustrating the configuration of a print head of a printer.

FIGS. 26A to 26D are explanatory views illustrating the effects in a printing system according to an embodiment of the invention.

FIGS. 27A and 27B are explanatory views illustrating the concept of white toning for adjusting a white color.

FIGS. 28A and 28B are explanatory views illustrating an example of color representation regions (gamut) of a color image and a white image.

FIG. 29 is an explanatory view schematically illustrating the configuration of a PC according to a second embodiment of the invention.

FIGS. 30A to 30C are explanatory views illustrating examples of a print image, color image data, and white image data per region according to a second embodiment of the invention.

FIG. 31 is a flowchart illustrating a flow of a toning white designation process by an application program according to a second embodiment of the invention.

FIG. 32 is an explanatory view illustrating an example of a toning white designation window according to a second embodiment of the invention.

FIG. 33 is a flowchart illustrating a flow of a region toning white designation process by an application program according to a third embodiment of the invention.

FIGS. 34A and 34B are explanatory views illustrating an example of a toning white designation window according to a third embodiment of the invention.

### DESCRIPTION OF EXEMPLARY EMBODIMENTS

Hereinafter, best modes (i.e. embodiments) for carrying out the invention will be described. The explanation will be made in the following order.

A. First embodiment
A-1. Configuration of a printing system
A-2. Toning white designation processing
A-3. Region toning white designation processing
A-4. Automatic toning white designation processing
B. Second embodiment
C. Third embodiment
D. Modified examples

### A. First Embodiment

### A-1. Configuration of a Printing System

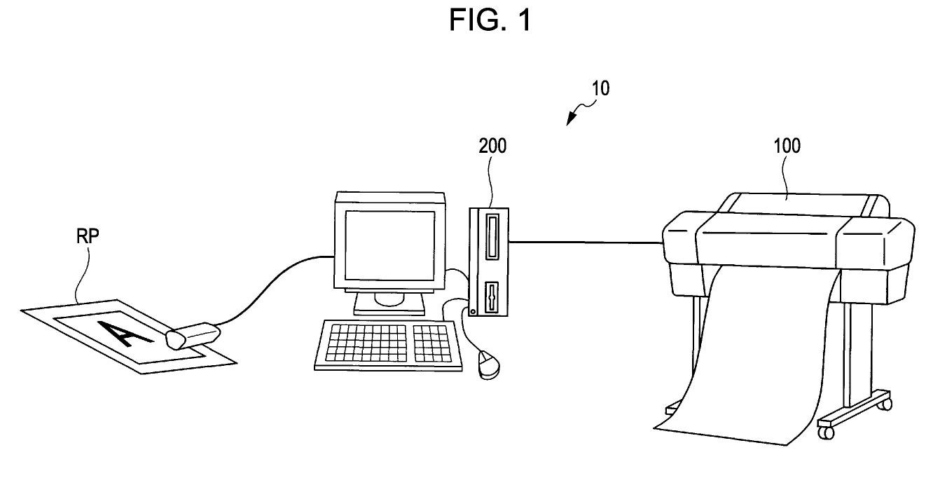

FIG. 1 is an explanatory view schematically illustrating the configuration of a printing system according to a first embodiment of the invention. The printing system 10 according to this embodiment includes a printer 100 and a personal computer (PC) 200. The printer 100 is an ink jet type color printer which prints an image by forming ink dots on a print medium (for example, print paper or transparent film) through injection of ink. The PC 200 functions as a print control apparatus, which supplies print data to the printer 100 and controls the printing operation of the printer 100. The printer 100 and the PC 200 are connected so that they can communicate with each other by wire or wirelessly to exchange information. Specifically, in this embodiment of the invention, the printer 100 and the PC 200 are connected with each other by a USB cable. In FIG. 1, for example, an actual print (hereinafter referred to as a “real print RP”) prepared through printing by a gravure printing machine is illustrated.

In this embodiment, the printer 100 is a printer that performs printing using seven color inks of cyan (c), magenta (M), yellow (Y), black (K), light cyan (Lc), light magenta (Lm), and white (W). In this embodiment, the printing system 10 realizes the printing process that simultaneously performs a color image and a white image on a transparent film as a print medium. The transparent film, on which the color image and the white image are formed, is used, for example, as a film for product packaging.

In the description of the invention, the term “white color” is not limited to a white color in the strict sense of the word, which is a surface color of an object that reflects all (100%) wavelengths of a visible light, and may include a color that is called a white color, as a socially accepted idea, such as “a color presenting a white light”. For example, “white color” may be (1) the color within a color range where in the case of performing color measurement using a color measurement device “eye-one Pro” of X-Rite, Inc, on condition of a color measurement mode: a spot mode, a light source: D50, backing: black, and a printing medium: a transparent film, the inscription in the LAB system is on the circumference of a radius 20 and inside the circumference on an a*b* plane and also L* is indicated to be equal to or larger than 70, (2) the color within a color where in the case of performing color measurement using a color measurement system CM2022 of Minolta Co., Ltd., on condition of a measurement mode of D502° visual field, SCF mode, and white background, the inscription in the LAB system is on the circumference of a radius 20 and inside the circumference on an a*b* plane and also L* is indicated to be equal to or larger than 70, or (3) the color of ink that is used as a background of an image as described in JP-A-2004-306591, and the color that is used as the background is not limited to a pure white color. In the description of the invention, it is called “white toning” to adjust the white color by mixing another color ink with the white ink, and the white color (adjusted white color) generated by the white toning is called “toning white”. Also, in the description of the invention, an image of white color is called a “white image”, and an image that is formed by the toning white among the white images is especially called a “toning white image”.

Also, in the description of the invention, a “print region” means a region where the printer 100 forms an image to be printed (hereinafter referred to as a “print image PI”) on a print medium (for example, a transparent film). The print region may be a portion of a region on the print medium or may be the whole region on the print medium.

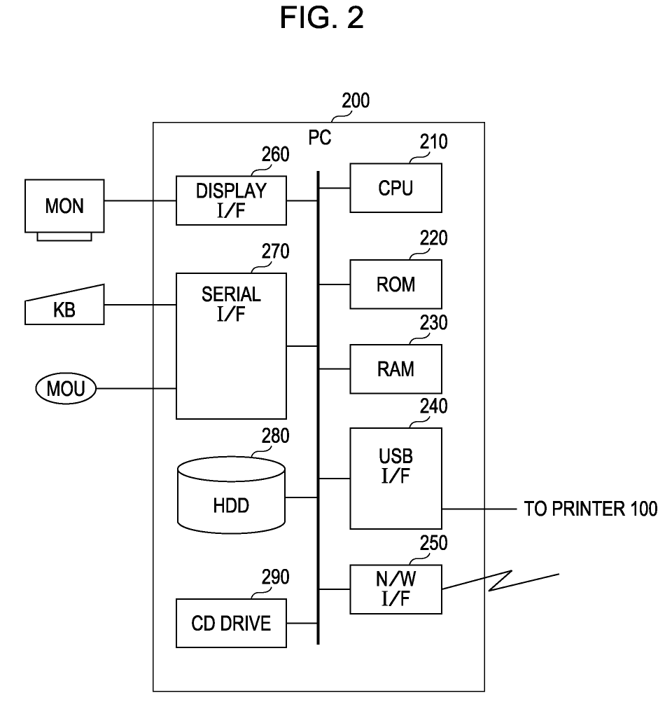

FIG. 2 is an explanatory view schematically illustrating the configuration of a PC 200. The PC 200 includes a CPU 210, a ROM 220, a RAM 230, a USB interface (USB I/F) 240, a network interface (N/W I/F) 250, a display interface (display I/F) 260, a serial interface (serial I/F) 270, a hard disc drive (HDD) 280, and a CD drive 290. Respective elements of the PC 200 are connected to one another through a bus.

A monitor MON as a display device is connected to the display interface 260 of the PC 200. A keyboard KB and a mouse MOU as input devices are connected to the serial interface 270. The configuration of the PC 200 as illustrated in FIG. 2 is merely exemplary, and modifications thereof, such as omission of a portion of the elements of the PC 200, addition of new elements to the PC 200, or the like, are possible.

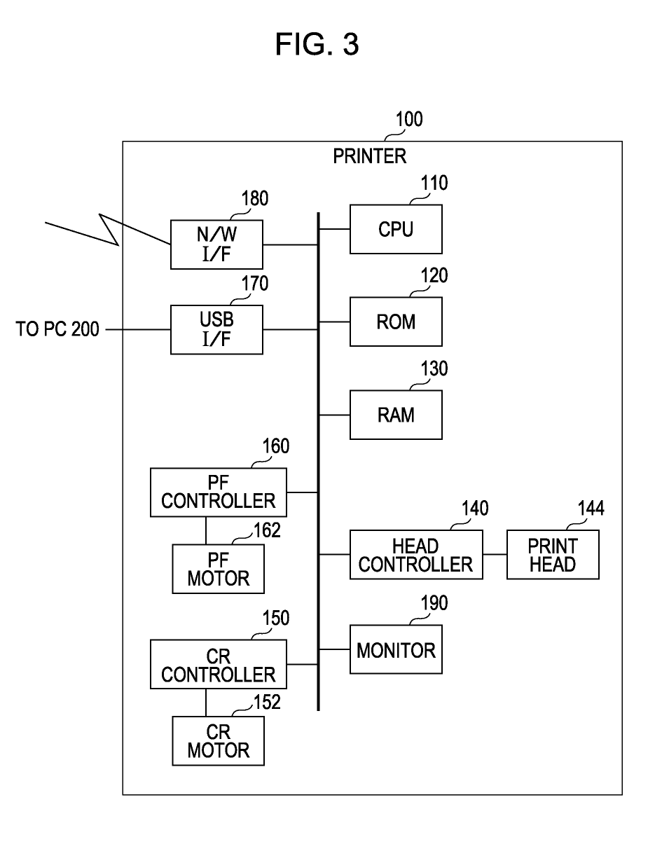

FIG. 3 is an explanatory view schematically illustrating the configuration of a printer 100. The printer 100 includes a CPU 110, a ROM 120, a RAM 130, a head controller 140, a print head 144, a carriage controller (CR controller) 150, a carriage motor (CR motor) 152, a print medium transfer controller (PF controller) 160, a print medium transfer motor (PF motor) 162, a USB interface (USB I/F) 170, a network interface (N/W I/F) 180, and a monitor 190 as a display unit. Respective elements of the printer 100 are connected to one another through a bus.

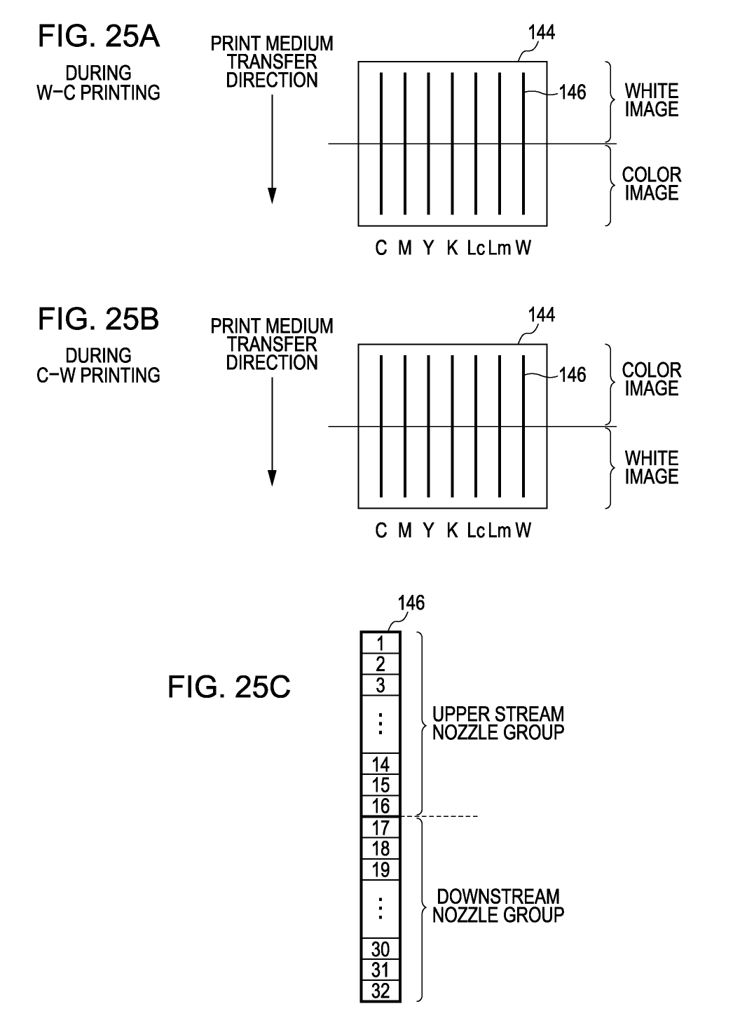

The CPU 110 of the printer 100 functions as a control unit that controls the whole operation of the printer 100 by executing a computer program stored in the ROM 120. The print head 144 of the printer 100 is installed in a carriage (not illustrated). The carriage controller 150 reciprocates the carriage in a predetermined direction by controlling the carriage motor 152. Accordingly, a main scanning, in which the print head 144 reciprocates along a predetermined direction (a main scanning direction) of the print medium, is realized. Also, the print medium transfer controller 160 and the print medium transfer motor 162 function as a print medium transfer mechanism. That is, the print medium transfer controller 160 performs a sub-scanning for transporting the print medium in a direction that is orthogonal to the main scanning direction (sub-scanning direction) by controlling the print medium transfer motor 162. The print head 144 has a nozzle group (see FIGS. 25A to 25C) for injecting ink, and the head controller 140 controls the ink injection from the nozzle group of the print head 144 in association with the main scanning and the sub-scanning. Accordingly, the forming of an image (image printing) onto the print medium is realized.

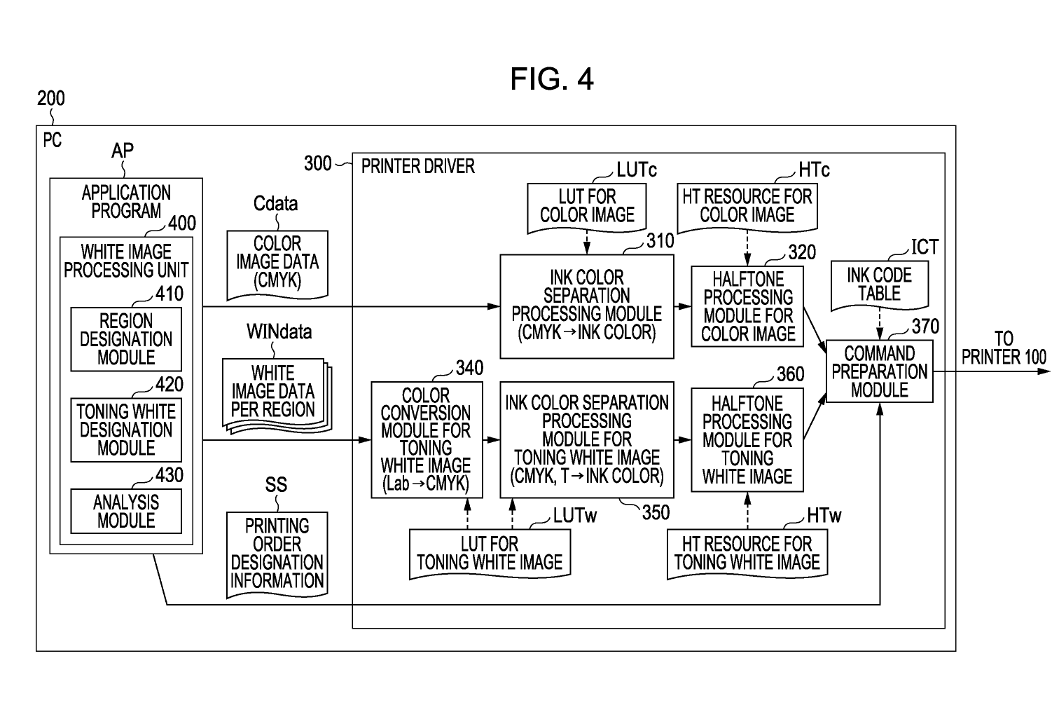

FIG. 4 is a block diagram functionally illustrating the configuration of the PC 200. In the ROM 220 (see FIG. 2) of the PC 200, an application program AP and the printer driver 300 are stored as computer programs executed by the CPU 210. The application program AP is a program for performing generation, edition, and the like, of the print image PI (target image to be printed) with respect to the print region of the print medium. The CPU 210 realizes generation and edition of the print image PI by executing the application program AP.

Also, the application program AP includes a white image processing unit 400. The white image processing unit 400 further includes an area designation module 410 as a toning white designation unit, a toning white designation module 420 as a toning white designation unit, and an analysis module 430 as an analysis unit. The CPU 210 that executes an application program AP outputs color image data Cdata, white image data WINdata per region, and printing order designation information SS to a printer driver 300 in accordance with a user's print execution instruction. Functions of the respective modules, the contents of respective information, and the contents of their data will be described later.

The printer driver 300 (see FIG. 4) as a print control unit is a program for generating data for printing (command for printing) based on data output from the application program AP and performing a printing process by controlling the printer 100 (see FIG. 1) based on the data for printing. The CPU 210 (see FIG. 2) realizes the control of printing by the printer 100 by executing the printer driver 300.

As illustrated in FIG. 4, the printer driver 300 includes an ink color separation processing module 310 for a color image, a halftone processing module 320 for a color image, a color conversion module 340 for a toning white image, an ink color separation processing module 350 for a toning white image, a halftone processing module 360 for a toning white image, and a command preparation module 370. Also, in an HDD 280 (see FIG. 2) of the PC 200, a lookup table (LUT) LUTc for a color image, a halftone (HT) resource HTc for a color image, a lookup table (LUT) LUTw for a toning white image, a halftone (HT) resource HTw for a toning white color, and an ink code table ICT are stored. The printer driver 300 and the respective modules perform the processing with reference to the information as above. The functions of the respective modules and the contents of the information will be described later.

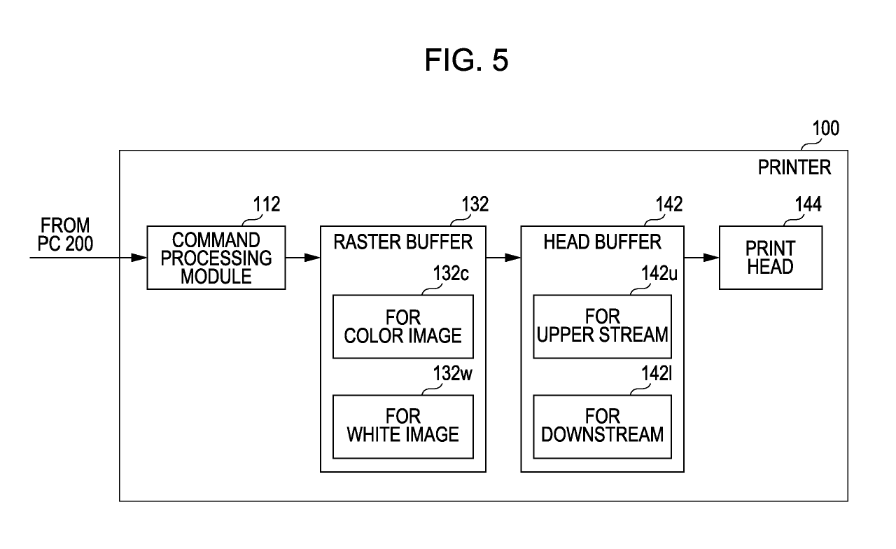

FIG. 5 is a block diagram functionally illustrating the configuration of the printer 100. In the ROM 120 (see FIG. 3) of the printer 100, a command processing module 112 is stored as a computer program executed by the CPU 110. As described later, the CPU 110 realizes the processing of a command for printing received from the PC 200 by executing the command processing module 112. Also, the RAM 130 (see FIG. 3) of the printer 100 has a raster buffer 132. The raster buffer 132 includes two regions of a raster buffer 132c for a color image and a raster buffer 132w for a white image. Also, the head controller 140 (see FIG. 3) of the printer 100 has a head buffer 142. The head buffer 142 includes an upper stream head buffer 142u and a downstream head buffer 1421. The functions and detailed configuration of the programs and buffers will be described later.

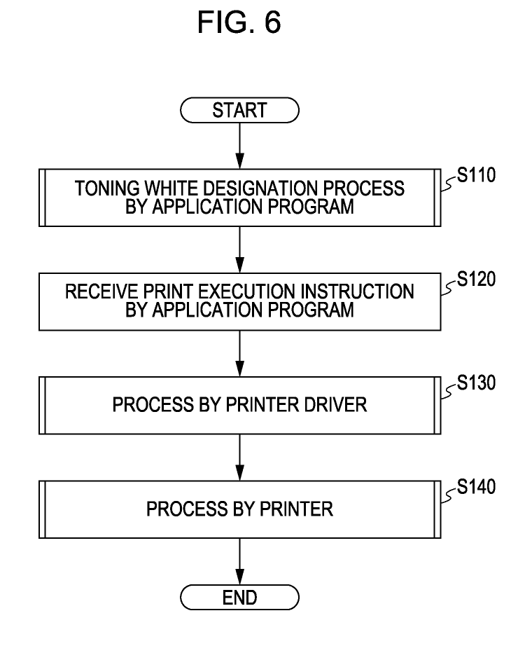

FIG. 6 is a flowchart illustrating a flow of processing in a printing system 10 according this embodiment of the invention. The printing system 10 according to this embodiment of the invention prepares a print on which a color image Ic and a white image Iw are formed by simultaneously forming the color image Ic and the white image Iw on the transparent film as the print medium PM.

In step S110, a toning white designation process is performed by the CPU 210 (see FIG. 2) that executes the application program AP (see FIG. 4). By this toning white designation process, the white image data WINdata per region and the printing order designation information SS are generated. In this case, the details of the toning white designation process will be described later. Next, in step S120, the CPU 210 receives a print execution instruction through the user's application program AP. The CPU 210 outputs the color image data Cdata, the white image data WINdata per region, and the printing order designation information SS to the printer driver 300 in accordance with the received print execution instruction (see FIG. 4).

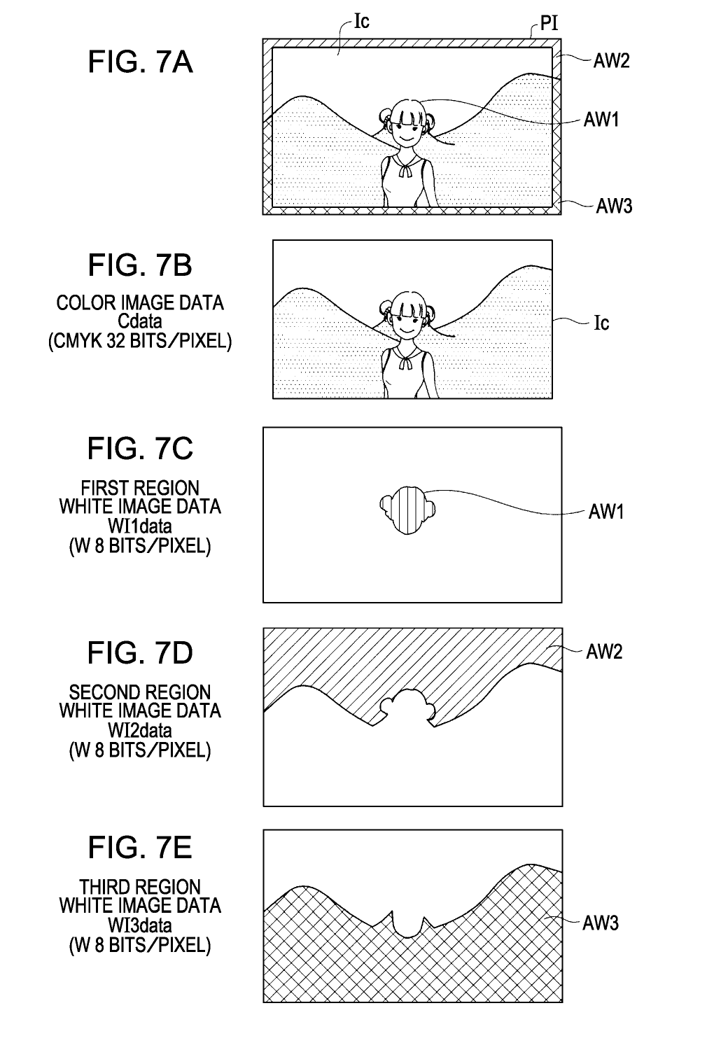

FIGS. 7A to 7E are explanatory views illustrating examples of the print image PI, the color image data Cdata, and the white image data WINdata per region. FIG. 7A shows an example of the print image PI. The print image PI includes a photographic image as the color image Ic and a white region. The white region is a region that corresponds to the white image (a region in which the white image is to be formed during printing), and is set as a region that is a little larger than the region where the color image Ic is arranged. Accordingly, when the print image PI is printed, the color image is formed to overlap the white image. This is to suppress an opposite side of the print being easily seen through the transparent film as the print medium in the position of the color image Ic.

Also, the white region is formed by a plurality of (one or more) partial regions optionally designated from the print region. In this embodiment, the white region is formed of three partial regions (a first partial region AW1, a second partial region AW2, and a third partial region AW3). The first partial region AW1 that is the first partial region is a region that corresponds to a face portion of a person of the color image Ic in the white region. The second partial region AW2 that is the second partial region is a region that corresponds to a blank portion of the color image Ic in the white region. The third partial region AW3 that is the third partial region is a region that corresponds to a portion except for the face portion of a person of the color image Ic and the blank portion in the white region.

FIG. 7B conceptually illustrates the color image data Cdata. In this embodiment, the color image data Cdata is data that specifies colors of respective pixels of the print image PI into 8-bit C, M, Y, and K values, respectively, in the case of giving attention only to the color image Ic of the print image PI. The color image data Cdata is data in which a pixel value that corresponds to the color image Ic of the print image PI is a value that specifies the color of the corresponding color image Ic, and the remaining pixel values are values indicating that the color image is not formed (for example, C, M, Y, K=0).

FIG. 7C conceptually illustrates first region white image data WI1data. In this embodiment, the first region white image data WI1data is data that specifies colors of respective pixels of the partial region AW1, in the case where the color image Ic is excluded from the print image PI, into 8-bit W values. However, the value that the W value can take is either “0” or “255”. Specifically, the first region white image data WI1data is data in which a pixel value that corresponds to the partial region AW1 of the print image PI is a value (for example, W=255) indicating that the white image is formed, and the remaining pixel value is a value (for example, W=0) indicating that the white image is not formed.

FIG. 7D conceptually illustrates second region white image data WI2data. In this embodiment, the second region white image data WI2data is data that specifies colors of respective pixels of the partial region AW2, in the case where the color image Ic is excluded from the print image PI, into 8-bit W values. However, the value that the W value can take is either “0” or “255” in the same manner as described above. Specifically, the second region white image data WI2data is data in which a pixel value that corresponds to the partial region AW2 of the print image PI is a value (for example, W=255) indicating that the white image is formed, and the remaining pixel value is a value (for example, W=0) indicating that the white image is not formed.

FIG. 7E conceptually illustrates third region white image data WI3 data. In this embodiment, the third region white image data WI3data is data that specifies colors of respective pixels of the partial region AW3, in the case where the color image Ic is excluded from the print image PI, into 8-bit W values. However, the value that the W value can take is either “0” or “255” in the same manner as described above. Specifically, the third region white image data WI3data is data in which a pixel value that corresponds to the partial region AW3 of the print image PI is a value (for example, W=255) indicating that the white image is formed, and the remaining pixel value is a value (for example, W=0) indicating that the white image is not formed.

In this case, the first region white image data WI1data, the second region white image data WI2data, and the third region white image data WI3data may also be data expressed by 2-bit value with respect to each pixel. Also, in the following description of the invention, “white image data WINdata per region” is a general term for the plurality of white image data (that is, the first region white image data WI1data, the second region white image data WI2data, and the third region white image data WI3data).

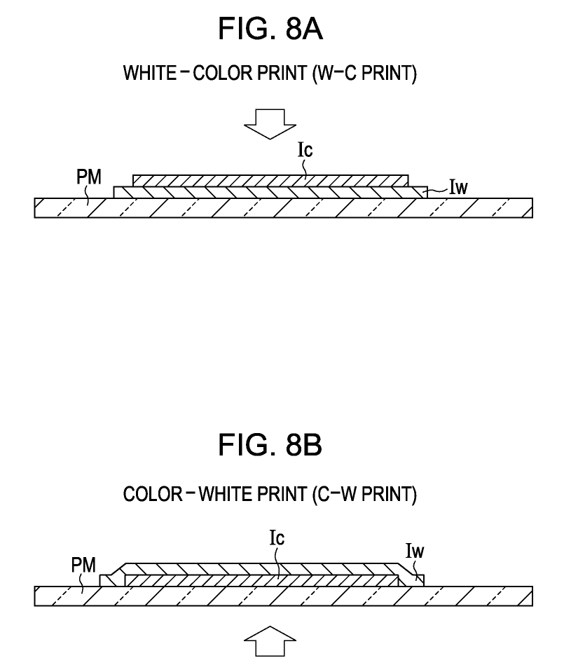

FIGS. 8A and 8B are explanatory views illustrating the printing order of a color image and a white image. FIG. 8A shows the printing order in which the white image Iw is formed on a transparent film as the print medium PM and then the color image Ic is formed on the white image Iw. In the description of the invention, this printing order is called “white-color printing” or “W-C printing”. In the W-C printing as illustrated in FIG. 8A, it is assumed that an observer observes a print from an upper side of the drawing (indicated by an arrow in the drawing).

FIG. 8B shows the printing order in which the color image Ic is formed on the transparent film as the print medium PM and then the white image Iw is formed on the color image Ic. In the description of the invention, this printing order is called “color-white printing” or “C-W printing”. In the C-W printing as illustrated in FIG. 8B, it is assumed that an observer observes a print from a lower side of the drawing (indicated by an arrow in the drawing). A user, in accordance with the use type of the print, selects whether to perform the W-C printing or the C-W printing (to be described later).

### A-2. Toning White Designation Processing

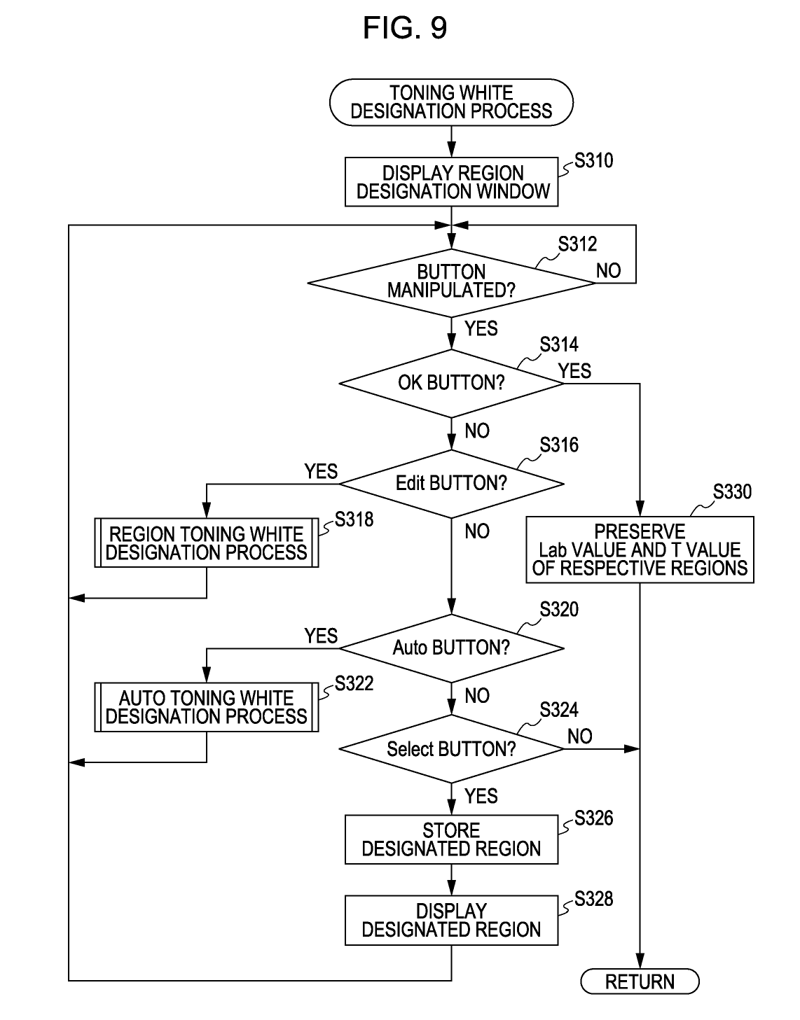

FIG. 9 is a flowchart illustrating a flow of a toning white designation process by an application program AP. In this embodiment, the toning white designation process is a process of designating white regions (a plurality of partial regions optionally determined from the print region) and designating the color of the white image (toning white image) that is formed on the corresponding white region. In step S310, a region designation module 410 (see FIG. 4) included in the white image processing unit 400 of the application program AP displays a region designation window for designating the white region on the monitor MON (see FIG. 2) of the PC 200.

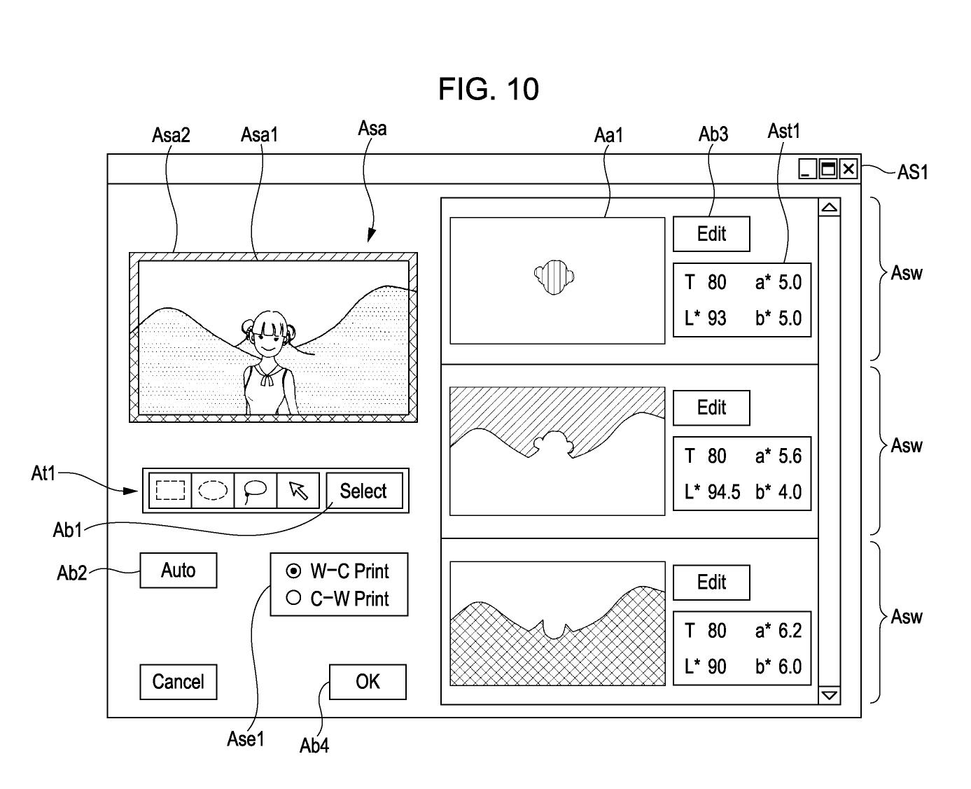

FIG. 10 is an explanatory view illustrating an example of a region designation window. As illustrated in FIG. 10, the region designation window AS1 includes a print region display area Asa, a toolbar At1, a select button Ab1, an auto button Ab2, a printing order designation section Ase1, an OK button Ab4, and three region display windows Asw.

In the print region display area Asa, the print region (that is, a region where the print image PI is formed) is displayed. The print region display area Asa includes a color image display area Asa1 and a white image display area Asa2. In the color image display area Asa1, an arbitrary color image is displayed. Also, in the white image display area Asa2, a sample image of the designated toning white is displayed. The toolbar At1 is a menu that includes plural kinds of select buttons. A user can select the arbitrary partial region on the sample image display area Asa using the plural kinds of select buttons of the toolbar At1. In this case, the arbitrary partial region on the sample image display area Asa selected by the user may be called a “user selection region”. The select button Ab1 is a button for storing information of the user selection region. The printing order designation section Ase1 is a designation section for designating the printing order as described above with reference to FIGS. 8A and 8B. The auto button Ab2 is a button for performing auto toning white designation process to be described later.

The region display window Asw includes a region image display area Aa1, an edit button Ab3, and a designated value display area Ast1. In the region image display area Aa1, an image for displaying the user selection region is displayed. The edit button Ab3 is a button for performing region toning white designation process to be described later with respect to the partial regions displayed in the region image display area Aa1. In the designated value display area Ast1, a designated value of the toning white, which is designated through the auto toning white designation processing or the region toning white designation processing, is displayed.

In step S312 of FIG. 9, the region designation module 410 monitors the existence/nonexistence of a user's manipulation through the keyboard KB or the mouse MOU (see FIG. 2) when the region designation window AS1 is displayed. If it is determined that the manipulation exists (“Yes” in step S312) and the manipulation is the pressing of the OK button Ab4 (“Yes” in step S314), the region designation module 410 preserves the LAB value and the T value of the respective regions (step S330). Specifically, the region designation module 410 preserves information of the user selection region that is displayed on the region image display area Aa1 of the region display window Asw in relation to the designated values (the LAB value and the T value) of the toning white that is displayed on the designated value display area Ast1. Thereafter, the region designation module 410 ends the processing.

In step S316, if it is determined that the manipulation is the pressing of the edit button Ab3 (“Yes” in step S316), the region designation module 410 performs the region toning white designation process to be described later (step S318). On the other hand, if it is determined that the manipulation is the pressing of the auto button Ab2 (“Yes” in step S320), the region designation module 410 performs the auto toning white designation process to be described later (step S322).

In step S324, if it is determined that the manipulation is the pressing of the select button Ab1 (“Yes” in step S324), the region designation module 410, in step S326, acquires information of the user selection region and stores information of the corresponding partial region. Also, in step S328, the region designation module 410 newly displays the image that displays the user selection region in the region image display area Aa1 of the region display window Asw. In this case, the values in the designated value display area Ast1 may be in a display state that corresponds to the default toning white. For example, the default state is a display state that corresponds to the LAB value and the T value which are preset as the colors of the white ink of the printer 100.

### A-3. Region Toning White Designation Processing

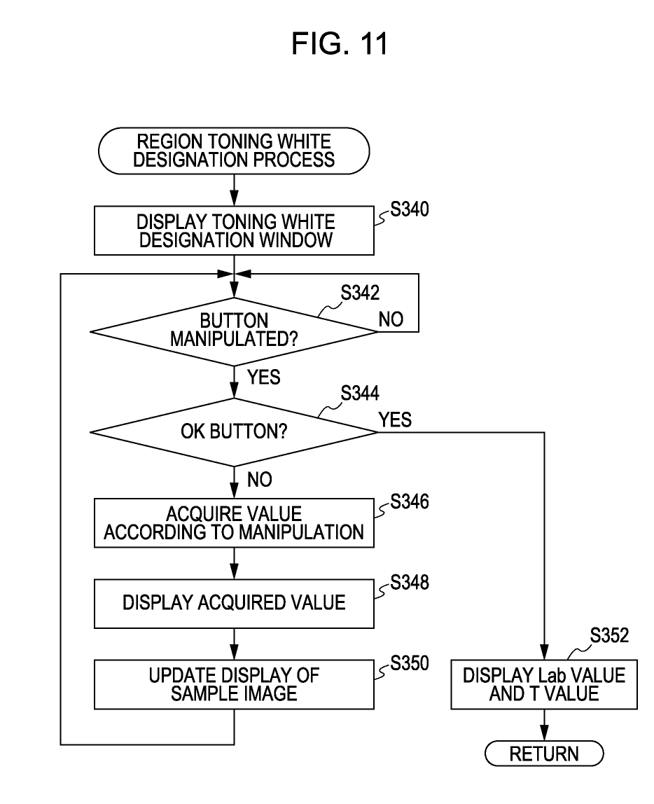

FIG. 11 is a flowchart illustrating a flow of a region toning white designation process by an application program AP. In this embodiment of the invention, the region toning white designation processing is a part of the toning white designation processing, and as described above with reference to FIGS. 9 and 10, is the process of designating the toning white with respect to the user selection region. In step S340, a toning white designation module 420 (see FIG. 4) that is included in the white image processing unit 400 of the application program AP displays a toning white designation window for designating the toning white on the monitor MON (see FIG. 2) of the PC 200.

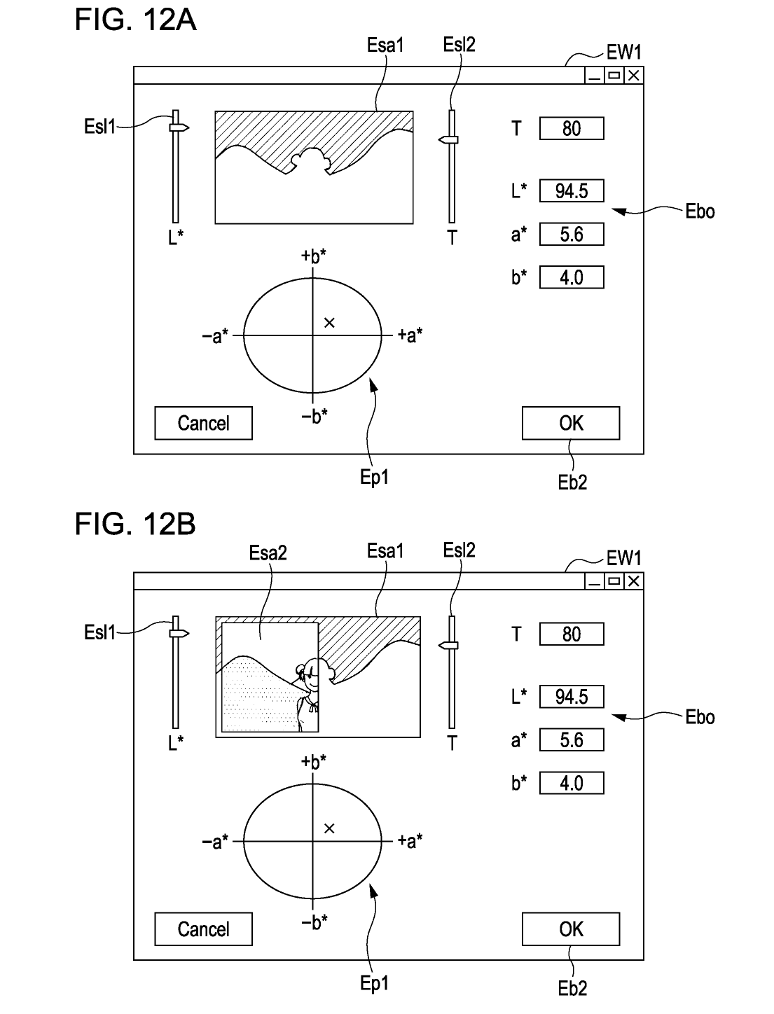

FIGS. 12A and 12B are explanatory views illustrating an example of a toning white designation window. FIG. 12A illustrates an example of a toning white designation window EW1. As illustrated in FIG. 12A, the toning white designation window EW1 includes a designated region display area Esa1, two slider bars Esl1 and Esl2, an ab-plane display area Ep1, a value input box Ebo, and an OK button Eb2.

In the designated region display area Esa1, an image that indicates the user selection region is displayed. A partial region that is indicated by hatching in the designated region display area Esa1 is a region for displaying the user selection region. Also, a region that is not hatched in the designated region display area Esa1 is a region that is not selected in the print region.

The value input box Ebo is a portion for designating the toning white by inputting a set of an color specification value (L* value) (hereinafter simply referred to as “L value”), an a* value (hereinafter simply referred to as “a value”), a b* value (hereinafter simply referred to as “b value”), and a T value in the L*a*b* color system. The L value is a value that indicates the brightness of the toning white, and is related to the amount of black (K) ink when the toning white image is printed. The a value and the b value are values that indicate the chromaticity according to the red-green axis and a yellow-blue axis of the toning white, and are related to the amount of color ink when the toning white image is printed. The T value is a value that indicates the density, and is related to the amount of ink per unit area when the toning white image is printed. That is, the T value is related to the permeability of a background color. Also, the two slider bars Esl1 and Esl2 and the ab-plane display area Ep1 are to designate the toning white by inputting the LAB value and the T value.

FIG. 12B illustrates another example of a toning white designation window EW1. In an example as illustrated in FIG. 12B, the toning white designation window EW1 further includes a color image display area Esa2. The color image display area Esa2 is installed in one of two divided areas that are obtained by dividing the designated region display area Esa1 right and left. In the color image display area Esa2, a portion of the color image is layer-displayed in the form of overlapping the image that indicates the user selection region displayed in the designated region display area Esa1. The layer of the color image is set to have a predetermined transparency. It is preferable that this predetermined transparency is determined after consideration of the permeability when the printing is actually performed. In this case, the transparency of the layer may be changeable.

In step S342 of FIG. 11, a toning white designation module 420 monitors the existence/nonexistence of user's manipulation through the keyboard KB or the mouse MOU (see FIG. 2) when the toning white designation window EW1 is displayed. If the manipulation is not the pressing of the OK button Eb2 (“No” in step S344), the toning white designation module 420 acquires the value according to the manipulation (step S346), displays the acquired value on the value input box Ebo or the like (step S348), and updates the display of the designated region display area Esa1 (step S350).

On the other hand, if the manipulation is the pressing of the OK button Eb2 (“Yes” in step S344, the toning white designation module 420 displays the designated values (the LAB value and the T value) of the toning white in the designated value display area Ast1 of the region display window Asw, which corresponds to the user selection region, of the region designation window AS1 (see FIG. 10), and ends the processing.

Specifically, for example, a user selects an optional kind of select button on the toolbar At1 using the mouse MOU (see FIG. 2) in a state where the region designation window AS1 as illustrated in FIG. 10 is displayed. Then, the user selects an optional partial region on the sample image display area Asa as the user selection region using the mouse MOU, and presses the select button Ab1. By the pressing of the select button Ab1, the user selection region is displayed on the region image display area Aa1 of the region display window Asw. At this time, it is possible to designate plural user selection regions. If plural user selection regions are designated, different region display windows Asw are displayed in the respective user selection regions. FIG. 10 illustrates an example where three user selection regions are designated. The user selects the desired designation of the toning white from the image that indicates the user selection region, and presses the edit button Ab3 of the corresponding region display window Asw.

By pressing the edit button Ab3 of the region designation window AS1 (see FIG. 10), the toning white designation window EW1 as illustrated in FIGS. 12A and 12B is displayed. In the toning white designation window EW1, if the user selects the value input box Ebo and inputs a value through the keyboard KB (see FIG. 2), the input value is displayed in the value input box Ebo, and the color of the white image region (the hatched area in FIGS. 12A and 12B) that corresponds to the user selection region of the designated region display area Esa1 is changed to a color (toning white) that is specified by the input value. If the user changes the a value or b value in the value input box Ebo, the color tone of the color (toning white) of the white image region of the designated region display area Esa1 is changed. Also, if the user changes the L value in the value input box Ebo, the brightness of the color in the white image region of the designated region display area Esa1 is changed. In the case where the user changes the T value in the value input box Ebo, the permeability of the background color is changed, and thus the brightness of the color of the white image region in the black background area of the designated region display area Esa1 is changed. At this time, in order to facilitate the confirmation of the brightness of the color of the white image region in the case where the T value of the value input box Ebo is changed, a black background area may be installed in a portion of the rear surface of the designated region display area Esa1.

Also, for example, if the user changes the position of the slide bar Esl1 by manipulating the mouse MOU (see FIG. 2), the L value according to the position is acquired, and the color of the designated region display area Esa1 is changed to a color that is specified by the acquired value. In the same manner, if the user changes the position of the slider bar Esl2 by manipulating the mouse MOU, the T value according to the position is acquired, and the color of the designated region display area Esa1 is changed. Also, if the user changes the position of the designated point (indicated by “x” in the drawing) of the ab-plane display area Ep1 by manipulating the mouse MOU, the a value and the b value according to the position of “x” are acquired, and the color of the designated region display area Esa1 is changed.

In this case, the value input box Ebo, the slider bars Esl1 and Esl2, and the ab-plane display area Ep1 interlock with one another. That is, if the value in the value input box Ebo is changed, the position of the slider bars Esl1 and Esl2 or the position of “x” in the ab-plane display area Ep1 is changed. In the same manner, if the position of the slider bars Esl1 and Esl2 or the position of “x” in the ab-plane display area Ep1 is changed, the changed designated value is displayed in the value input box Ebo.

### A-4. Automatic Toning White Designation Processing

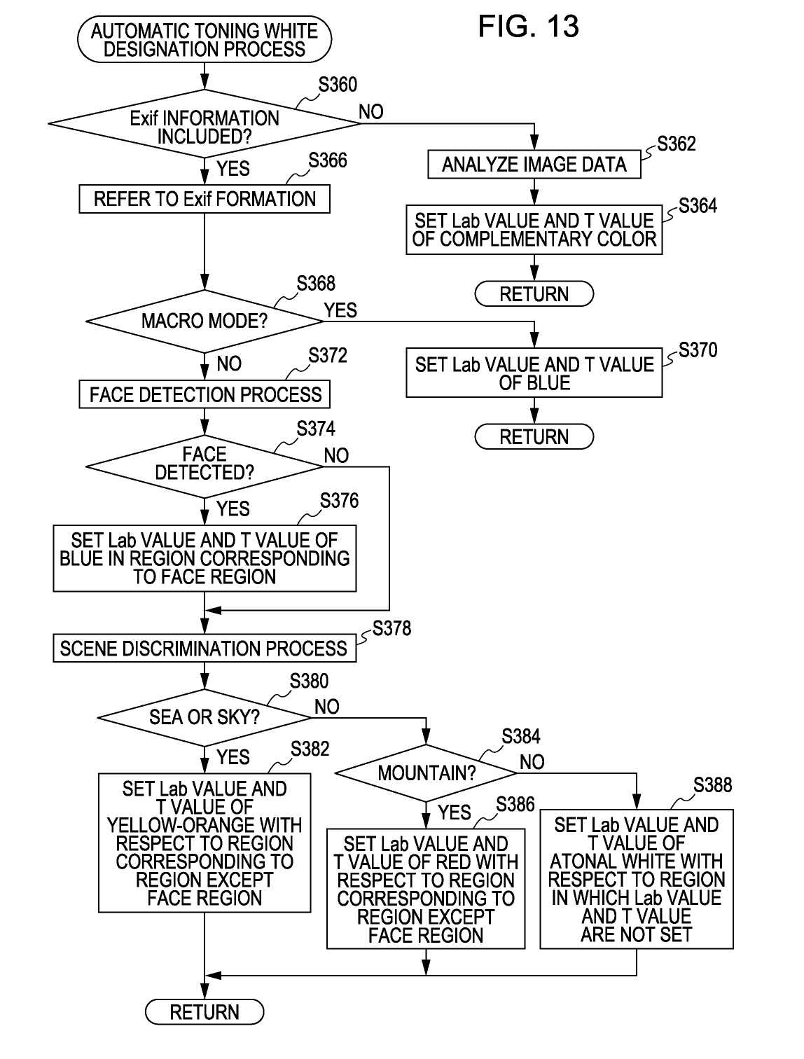

FIG. 13 is a flowchart illustrating a flow of automatic toning white designation process by an application program AP. In this embodiment, the automatic toning white designation processing is a part of the toning white designation processing, and an analysis module 430 of the white image processing unit 400 performs analysis of an arbitrary color image that is displayed in the print region display area Asa (see FIG. 10) to select the partial region and to designate the toning white.

In step S360, the analysis module 430 determines whether Exif (Exchangeable Image File Format) information is included in the color image data Cdata of the color image that is displayed in the print region display area Asa (see FIG. 10). The Exif information is information that is related to the picture quality when the color image data Cdata is generated (photographed), and includes a shutter speed, an exposure mode, an ISO sensitivity, an iris value, a photographed scene, a color space for photography, and the like.

If the Exif information is not included (“No” in step S360), the analysis module 430, in step S362, calculates an average of the pixel values of the color image data Cdata by analyzing the color image data Cdata. The average of the pixel values can be calculated by sampling the color image data Cdata in the unit of a pixel (or for each predetermined pixel) and then obtaining the average thereof. Also, the analysis module 430 sets the characteristic color of the color image data Cdata from the calculated average of the pixel values. Then, in step S364, the analysis module 430 sets the LAB value and the T value for forming the toning white image having a color that is the complementary color of the corresponding characteristic color with respect to all regions on the print region display area Asa, and ends the processing.

On the other hand, if the Exif information is included in the color image data Cdata (“Yes” in step S360), the analysis module 430, in step S366, refers to the Exif information of the color image data Cdata. Then, in step S368, the analysis module 430 determines whether the color image data Cdata has been photographed in a macro mode from the corresponding Exif information. If the color image data Cdata has been photographed in the macro mode (“Yes” in step S368), the analysis module 430 estimates that the color image data Cdata corresponds to an image where a flower has been largely photographed. Due to this, the analysis module 430 determines that the characteristic color that characterizes the color image data Cdata is red, sets the LAB value and the T value for forming the toning white image having a bluish green color that is the complementary color of the characteristic color (red) with respect to all regions on the print region display area Asa, and ends the processing (step S370).

If the color image data Cdata has not been photographed in the macro mode (“No” in step S368), the analysis module 430, in step S372, performs a face detection process (process of detecting an image region that includes at least a portion of the face image as the face region). This face detection process can be performed using the known face detection technique. Examples of the known face detection technique includes, for example, technique by pattern matching, technique by skin color region extraction, technique using study data set by study (for example, study using a neutral network, study using boosting, study using a support vector machine, or the like) using a sample face image, and the like.

In step S374, the analysis module 430 determines whether the face region is detected from the color image data Cdata. If the face region is detected (“Yes” in step S374), the analysis module 430, in step S376, stores information for specifying the face region, and determines that the characteristic color of the corresponding face region in the color image data Cdata is a skin color (yellow-orange). Then, the analysis module 430 sets the LAB value and the T value for forming the toning white image having a blue color that is the complementary color of the characteristic color (yellowish red) with respect to the partial region that corresponds to the face region on the print region display area Asa. If the face region is not detected (“No” in step S374), the analysis module 430 is shifted to step S378.

In step S378, the analysis module 430 discriminates the photographed scene of the color image data from the Exif information of the color image data Cdata. If it is determined that the photographed scene of the color image data Cdata is the sea or sky (“Yes” in step S380), the analysis module 430 determines that the characteristic color of the corresponding region in the color image data Cdata is blue. Also, in step S382, the analysis module 430 sets the LAB value and the T value for forming the toning white image having a yellow-orange color that is the complementary color of the characteristic color (blue) with respect to the partial region that corresponds to the region except for the face region on the print region display area Asa, and ends the processing.

On the other hand, if it is determined that the photographed scene of the color image data Cdata is not the sea or sky (“No” in step S380), but is a mountain (“Yes” in step S384), the analysis module 430 determines that the characteristic color of the corresponding region in the color image data Cdata is bluish green. Then, in step S386, the analysis unit 430 sets the LAB value and the T value for forming the toning white image having a red color that is the complementary color of the characteristic color (bluish green) with respect to the partial region that corresponds to the region except for the face region on the print region display area Asa, and ends the processing.

If it is determined that the photographed scene of the color image data Cdata is not the sea or sky (“No” in step S380), and also is not the mountain (“No” in step S384), the analysis module 430 does not determine the characteristic color of the corresponding region in the color image data Cdata. Then, in step S388, the analysis module 430 sets the LAB value and the T value for forming the atonal white image with respect to the partial region that corresponds to the region except for the face region on the print region display area Asa, and ends the processing. At this time, if the photographed scene is not discriminated, the same processing as described in steps S360 to S364 is performed, so that the characteristic color is determined from the average of the pixel values of the color image data Cdata, and the LAB value and the T value for forming the toning white image are set.

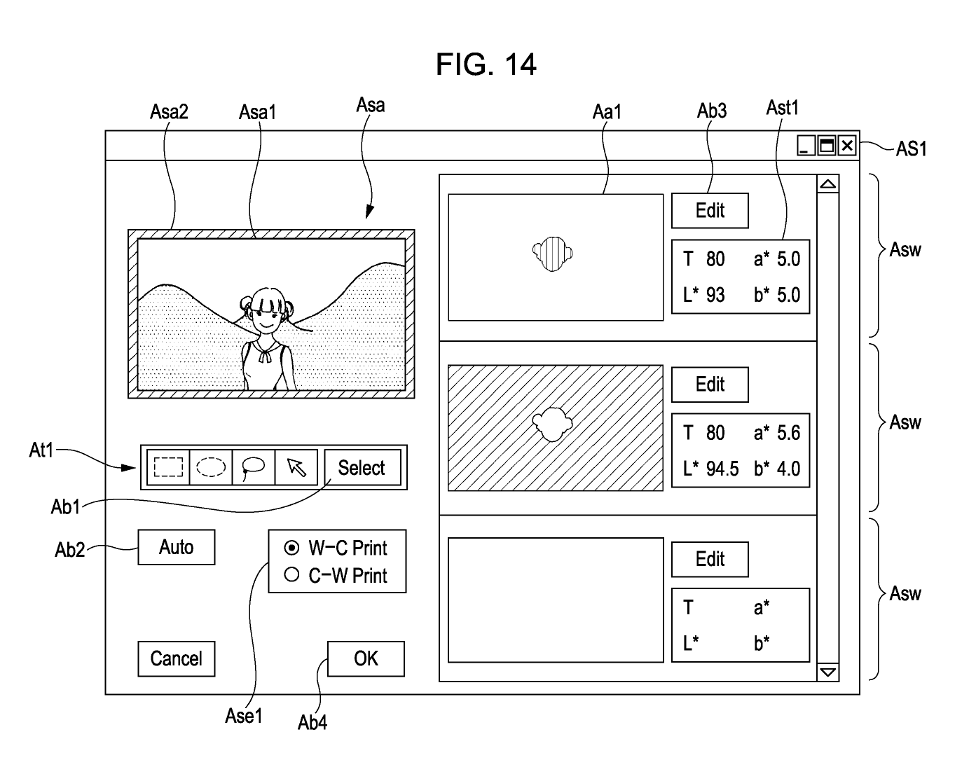

FIG. 14 is an explanatory view illustrating a region designation window AS1 after an automatic toning white designation process is performed. As illustrated in the drawing, as a result of performing the face detection (steps S372 to S376 in FIG. 13) with respect to the color image that is displayed in the print region display area Asa, an image with a detected face region, which is displayed on an upper end portion of the region display window Asw, is displayed. In the designated value display area Ast1, the LAB value and the T value for forming the toning white image having a blue color that is the complementary color of the characteristic color (yellowish red) are displayed. Further, as a result of performing the scene discrimination (steps S378 to S388 in FIG. 13) with respect to the color image that is displayed in the print region display area Asa, an image with a portion except for the face region, which is displayed on an intermediate portion of the region display window Asw, is displayed. In the designated value display area Ast1, the LAB value and the T value for forming the toning white image having a red color that is the complementary color of the characteristic color (bluish green) are displayed. In this case, nothing is displayed in the lower portion of the region display window Asw. Also, the LAB value and the T value that is displayed in the designated value display area Ast1 can be changed in accordance with the user's taste by pressing the edit button Ab3.

As described above, if the user presses the OK button Ab4 in the region designation window AS1 (see FIG. 10), the toning white designation processing is ended. The LAB value and the T value, which are preserved by pressing the OK button Ab4, are combined with information for specifying the corresponding partial region, and white image data WINdata per region (a plurality of white image data, for example, the first region white image data WI1data, the second region white image data WI2data, and the like) are generated. In the description of the invention, the white image data WINdata per region, which corresponds to the LAB value and the T value, is called toning white image data.

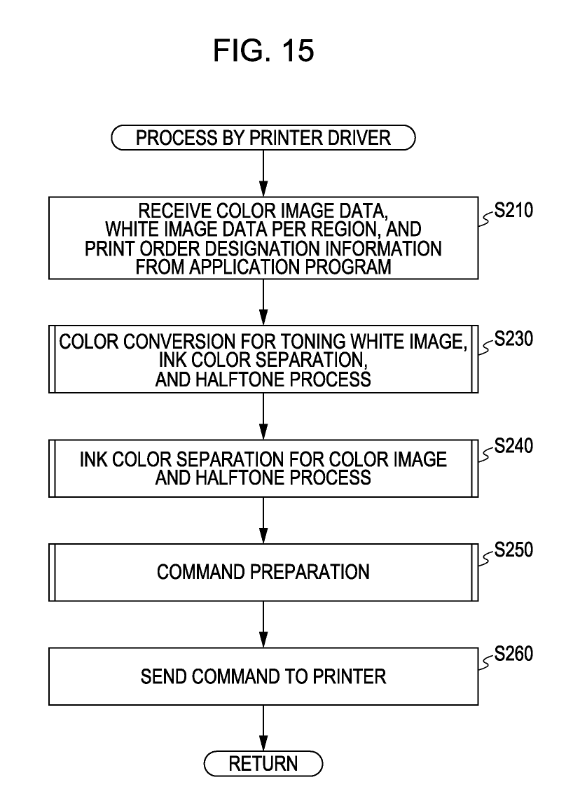

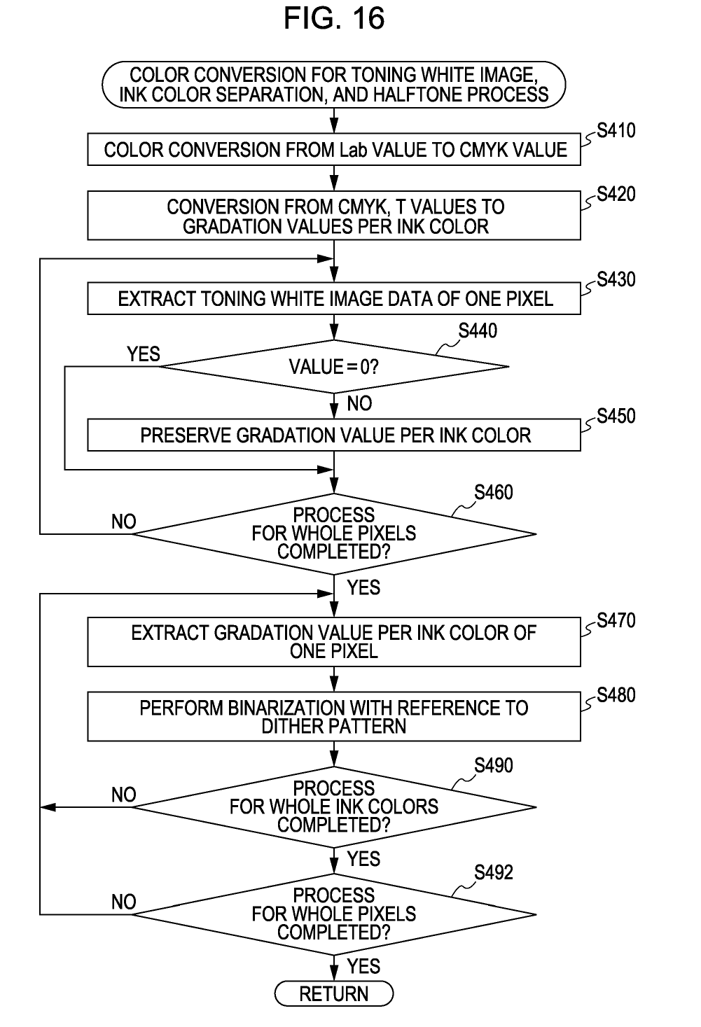

In step S130 of FIG. 6, the processing by the CPU 210 that executes the printer driver 300 (see FIG. 4) is performed. FIG. 15 is a flowchart illustrating a flow of processing by the CPU 210 that executes the printer driver 300. In step S210, the CPU 210 receives the color image data Cdata output from the application program AP, the white image data WINdata per region, and the printing order designation information SS (see FIG. 4). Next, in step S230, the printer driver 300 executes the color conversion processing for the toning white image, the ink color separation processing, and the halftone processing. FIG. 16 is a flowchart illustrating a flow of the color conversion processing for the toning white image, the ink color separation processing, and the halftone processing. In step S410, the color conversion module 340 for the toning white image (see FIG. 4) converts the LAB value preserved in step S330 of the toning white designation processing (see FIG. 9) into CMYK value. This color conversion is executed with reference to a lookup table LUTw for the toning white image (see FIG. 4).

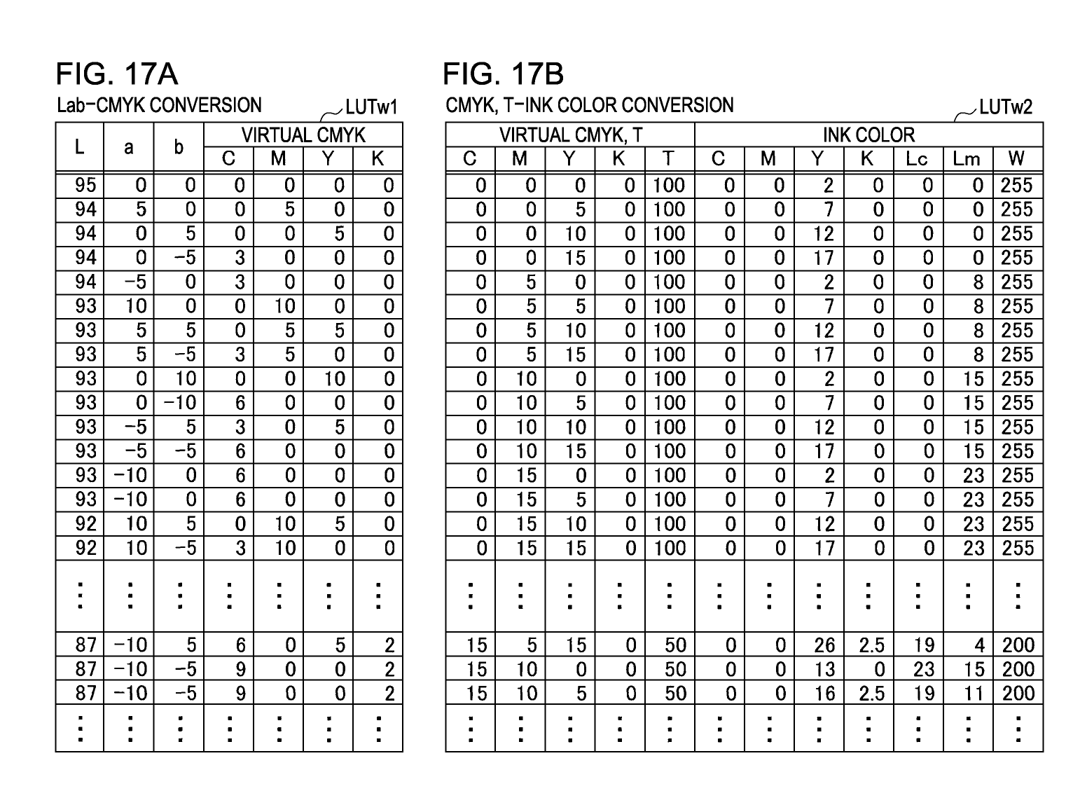

FIGS. 17A and 17B are explanatory views partially illustrating an example of the lookup table LUTw for the toning white image. FIG. 17A illustrates the lookup table LUTw1 for the toning white image that is referred to when the color conversion of the LAB value into the CMYK value is performed. As illustrated in FIG. 17A, in the lookup table LUTw1 for the toning white image, a correspondence relationship between a preset LAB value and the CMYK value has been prescribed. In the lookup table LUTw1 for the toning white image, respective gradation values of the CMYK have been prescribed as values in the range of 0 to 100. The color conversion module 340 for the toning white image converts the LAB value into the CMYK value with reference to the lookup table LUTw1 for the toning white image.

In step S420 of FIG. 16, the ink color separation processing module 350 for the toning white image (see FIG. 4) performs the ink color separation processing that converts a combination between the CMYK value determined in step S410 and the T value preserved in step S330 of the toning white designation processing (see FIG. 9) into gradation values per ink color. As described above, the printer 100 according to this embodiment performs printing using 7 color inks of cyan (c), magenta (M), yellow (Y), black (K), light cyan (Lc), light magenta (Lm), and white (W). Accordingly, in the ink color separation processing, the combination between the CMYK value and the T value is converted into respective gradation values of the 7 ink colors. The ink color separation processing is also executed with reference to the lookup table LUTw for the toning white image (see FIG. 4).

FIG. 17B illustrates the lookup table LUTw2 for the toning white image that is referred to when the conversion of the combination between the CMYK value and the T value into the gradation value per ink color is performed. As illustrated in FIG. 17B, in the lookup table LUTw2 for the toning white image, a correspondence relationship between the combination between the preset CMYK value and the T value and the gradation values of the ink colors has been prescribed. In the lookup table LUTw2 for the toning white image, gradation values of the ink colors have been prescribed as values in the range of 0 to 255. The ink color separation processing module 350 for the toning white image converts the combination between the CMYK value and the T value into the gradation values per ink color with reference to the lookup table LUTw2 for the toning white image.

As illustrated in FIG. 17B, in this embodiment of the invention, four color inks of yellow (Y), black (K), light cyan (Lc), and light magenta (Lm) are used among 6 color inks except for the white color in the white toning (the adjustment of the white color by mixing another color ink with the white ink), but two color inks of cyan (c) and magenta (M) are not used. That is, in the white toning, of the light color ink and the dark color ink having the same color, the dark color ink is not used.

In step S430 of FIG. 16, the ink color separation processing module 350 for the toning white image (see FIG. 4) extracts data of one pixel in the toning white image data. In step S440, the ink color separation processing module 350 for the toning white image determines whether the value of the extracted pixel is a value (zero) indicating that the toning white image is not formed or a value (255) indicating that the toning white image is formed. If it is determined that the pixel value is 255 (“No” in step S440), the ink color separation processing module 350 for the toning white image preserves the gradation value per ink color that is determined in step S420 (step S450). On the other hand, if it is determined that the pixel value is 0 (zero) (“Yes” in step S440), the processing in step S450 is skipped.

The processing from step S430 to step S450 in FIG. 16 is repeatedly performed until the processing of all pixels of the toning white image data is completed (step S460). If the processing of the whole pixels is completed (“Yes” in step S460), the halftone processing module 360 for the toning white image (see FIG. 4) extracts the gradation value per ink color of one pixel (step S470), and performs binarization processing (halftone processing) with reference to a dither pattern per ink color (step S480). The binarization processing is performed with reference to the preset halftone resource HTw for the toning white image (see FIG. 4). In this case, the halftone resource HTw for the toning white image may be set taking a serious view of the burying of dots in the toning white image. The binarization processing is repeatedly performed until the processing of the whole ink colors is completed (step S490). Also, the processing from step S470 to step S490 is repeatedly performed until the processing of all pixels is completed (step S492).

Through the color conversion processing for the toning white image, the ink color separation processing, and the halftone processing as illustrated in FIG. 16, the dot data for the toning white image, which prescribes ON/OFF of the dots of the respective ink colors of the respective pixels when the toning white image is formed, is generated.

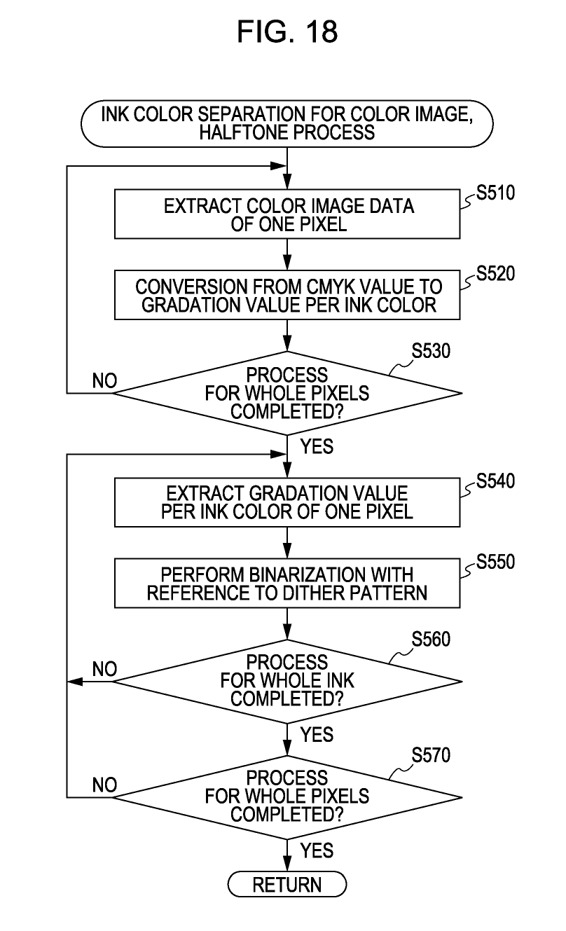

In step S240 that is processed by the printer driver 300 as illustrated in FIG. 15, the printer driver 300 performs the color conversion processing for the color image, the ink color separation processing, and the halftone processing. FIG. 18 is a flowchart illustrating a flow of the color conversion processing for the color image, the ink color separation processing, and the halftone processing. In step S510, the ink color separation processing module 310 for the color image (see FIG. 4) extracts data of one pixel in the color image data. In step S520, the ink color separation processing module 310 for the color image performs ink color separation processing that converts the extracted data (CMYK value) of one pixel into a gradation value per ink color. As described above, in this embodiment, the printer 100 performs printing using 7 color inks of cyan (c), magenta (M), yellow (Y), black (K), light cyan (Lc), light magenta (Lm), and white (W). Accordingly, in the ink color separation processing, the CMYK value is converted into gradation values of 7 ink colors. The ink color separation processing is performed with reference to the lookup table LUTc for the color image (see FIG. 4).

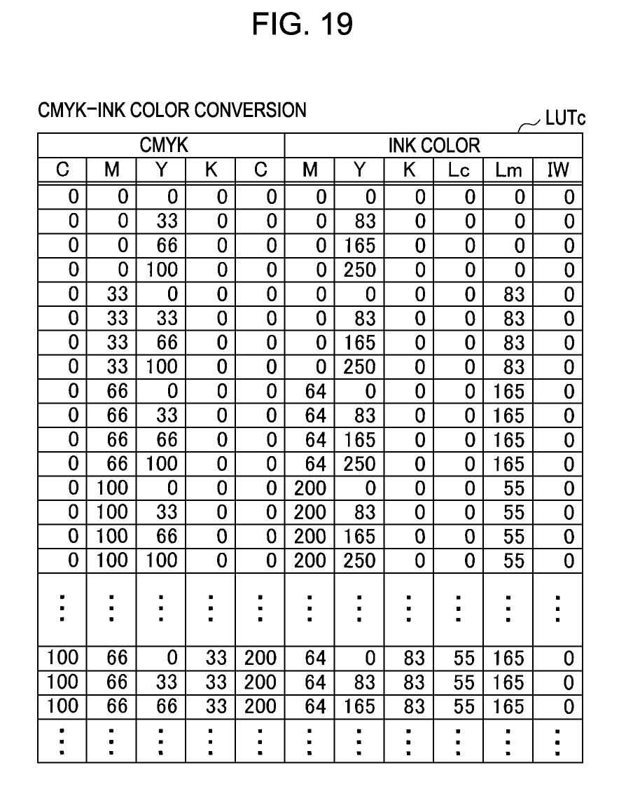

FIG. 19 is an explanatory view partially illustrating an example of the lookup table LUTc for the color image. As illustrated in FIG. 19, in the lookup table LUTc for the color image, a correspondence relationship between a preset CMYK values and gradation values of the ink colors has been prescribed. In the lookup table LUTc for the color image, respective gradation values of the CMYK have been prescribed as values in the range of 0 to 100, and the gradation values of the ink color have been prescribed as values in the range of 0 to 255. The ink color separation processing module 310 for the color image converts the CMYK value into a gradation value per ink color with reference to the lookup table LUTc for the color image. As illustrated in FIG. 19, in this embodiment, 6 color inks except for the white color are used to form the color image, and the white ink is not used.

The processing from step S510 to step S520 in FIG. 18 is repeatedly performed until the processing of all pixels of the color image data is completed (step S530). If the processing of the whole pixels is completed (“Yes” in step S530), the halftone processing module 320 for the color image (see FIG. 4) extracts the gradation value per ink color of one pixel (step S540), and performs binarization processing (halftone processing) with reference to a dither pattern per ink color (step S550). The binarization processing is performed with reference to the predetermined halftone resource HTc for the predetermined color image (see FIG. 4). In this case, the halftone resource HTc for the color image may be set taking a serious view of the suppression of granularity. The binarization processing is repeatedly performed until the processing of the whole ink colors is completed (step S560). Also, the processing from step S540 to step S560 is repeatedly performed until the processing of all pixels is completed (step S570).

By the color conversion processing for the color image, the ink color separation processing, and the halftone processing as illustrated in FIG. 18, dot data for the color image, which prescribes ON/OFF of the dots of the respective ink colors of the respective pixels when the color image is formed, is generated.

In step S250 that is processed by the printer driver 300 as illustrated in FIG. 15, a command preparation module 370 of the printer driver 300 (see FIG. 4) performs command preparation processing. The command preparation processing is processing that generates a print command for controlling the printing process by the printer 100 based on the dot data for the toning white image and the color image generated by the halftone processing for the toning white image and the color image (steps S230 and S240 in FIG. 15) and the printing order designation information SS (see FIG. 4) output from the application program AP.

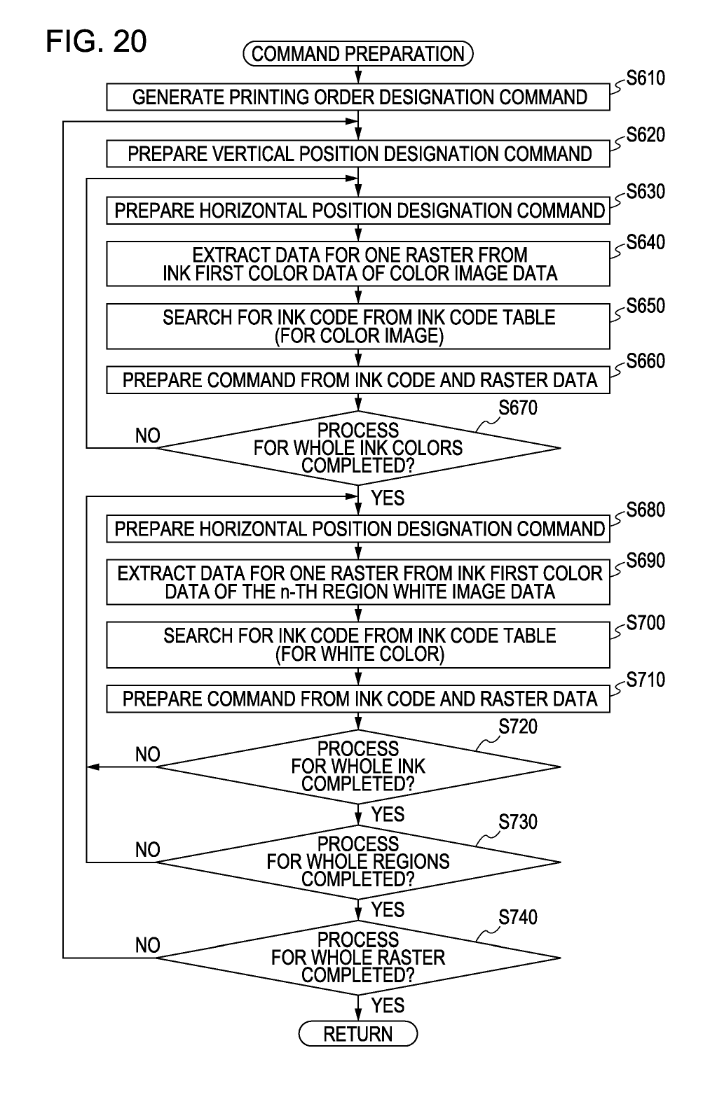

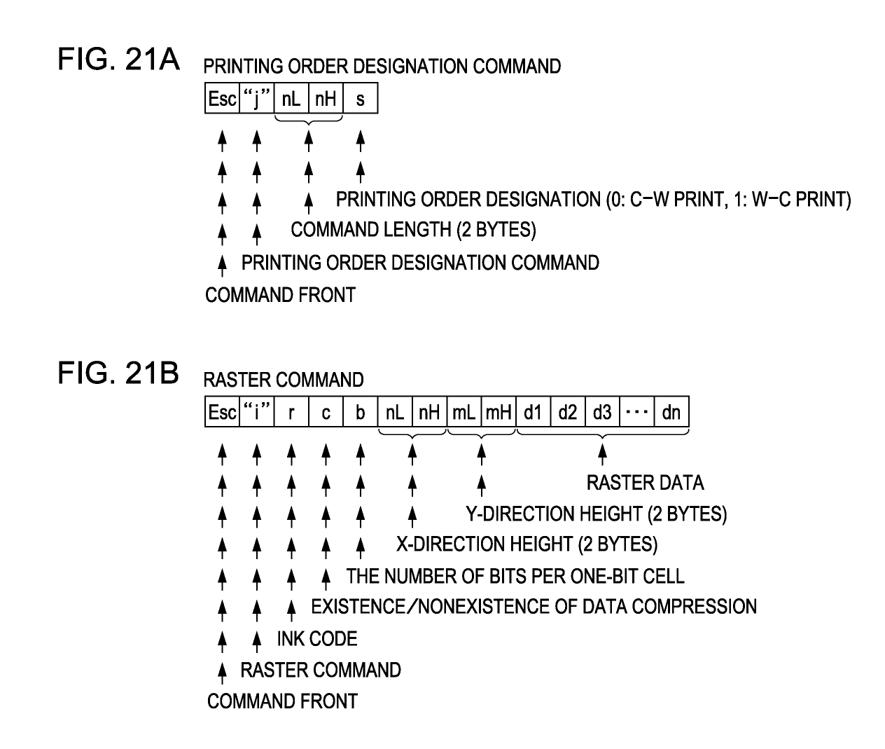

FIG. 20 is a flowchart illustrating a flow of command preparation processing. In step S610, the command preparation module 370 (see FIG. 4) prepares the printing order designation command based on the printing order designation information SS output from the application program AP. FIGS. 21A and 21B are explanatory views illustrating an example of a command prepared by the command preparation processing. FIG. 21A shows an example of the printing order designation command. As illustrated in FIG. 21A, the printing order designation command includes an identifier indicating a command header, an identifier indicating the printing order designation command, a command length (2 bytes), and printing order designation. In designating the printing order, for example, the value “0” indicates the C-W printing (the printing order in which the color image Ic is first formed, and then the white image Iw is formed on the color image Ic), and the value “1” indicates the W-C printing (the printing order in which the white image Iw is first formed, and then the color image Ic is formed on the white image Iw). The command preparation module 370 specifies the printing order with reference to the printing order designation information SS, and prepares the printing order designation command for designating the specified printing order.

In step S620 (see FIG. 20), the command preparation module 370 (see FIG. 4) prepares a vertical position designation command based on the dot data for the color image received from the halftone processing module 320 for the color image and the dot data for the toning white image received from the halftone processing module 360 for the toning white image. The vertical position designation command is a command for designating the start position of the image that follows the vertical direction (Y direction). The vertical position designation command is prepared as a command common to the whole ink.

Then, the command preparation module 370 (see FIG. 4) prepares a raster command that corresponds to the color image through the processing from step S630 to step S670 as illustrated in FIG. 20. In step S630, the command preparation module 370 prepares the horizontal position designation command for one selected ink color based on the dot data for the color image. The horizontal position designation command is a command for designating the start position of the image that follows the horizontal direction (X direction) for one ink color when the color image is formed. The command preparation module 370 sets an appropriate image start position with reference to the dot data for the color image for one ink color, and prepares the horizontal position designation command.

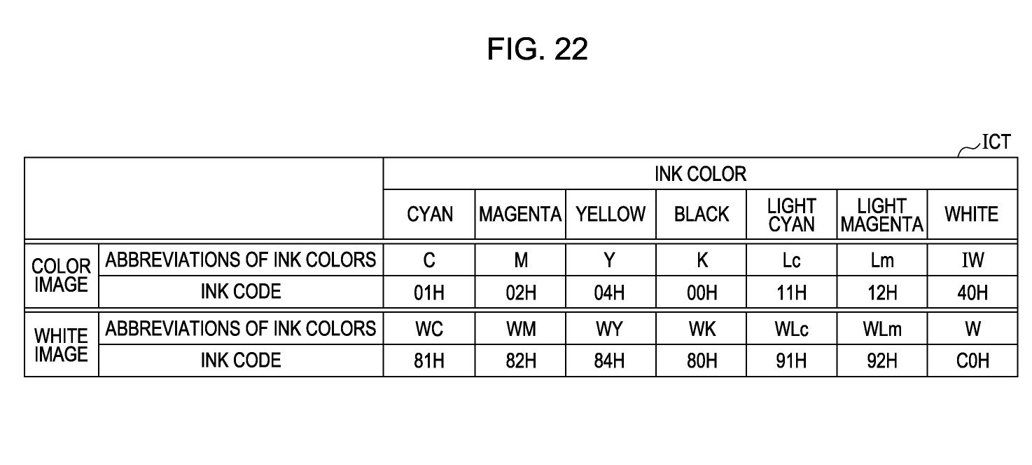

In step S640 (see FIG. 20), the command preparation module 370 (see FIG. 4) extracts the dot data for one raster for one selected ink color from the dot data for the color image. In step S650, the command preparation module 370 searches for an ink code with reference to an ink code table ICT. FIG. 22 is an explanatory view illustrating an example of the contents of the ink code table ICT. As illustrated in FIG. 22, in this embodiment, each ink color is allocated with an inherent ink abbreviation and an ink code. Further, in this embodiment, one ink color is allocated with two kinds of different ink abbreviations and ink codes for the color image and the white image. That is, the ink abbreviation and the ink code consistently correspond to combinations of the respective ink colors and the color image and the white image. For example, cyan for the color image is allocated with an ink abbreviation “C” and an ink code “01H”, and cyan for the white image is allocated with an ink abbreviation “WC” and an ink code “81H”. In the same manner, white for the color image is allocated with an ink abbreviation “IW” and an ink code “40H”, and white for the white image is allocated with an ink abbreviation “W” and an ink code “C0H”. In step S650, the command preparation module 370 searches for the ink code for the color image in the ink code table ICT.

In step S660 (see FIG. 20), the command preparation module 370 (see FIG. 4) prepares the raster command based on the extracted dot data for one raster and the searched ink code. FIG. 21B shows an example of a raster command. As illustrated in FIG. 21B, the raster command includes an identifier indicating a command header, an identifier indicating the raster command, an ink code, an identifier indicating existence/nonexistence of data compression, the number of bits for one pixel, X-direction length (2 bytes), Y-direction length (2 bytes), and raster data (dot data).

The processing from step S630 to step S660 for the command preparation processing (see FIG. 20) is repeatedly performed until all ink colors used to form the color image are completed. That is, if there is any ink color that has not yet become a target to be processed (“No” in step S670), one ink color that has not become a target to be processed is selected, and the processing from step S630 to step S660 is performed with respect to the selected ink color. If the processing of the whole ink is completed (“Yes” in step S670), the preparation of raster commands corresponding to the respective ink colors used to form the color image is completed with respect to one raster.

Then, the command preparation module 370 (see FIG. 4) prepares raster commands corresponding to the toning white image of the plurality of partial region AW1 to Awn which are optionally determined from the print region through the processing from step S680 to step S730 as illustrated in FIG. 20. In step S680, the command preparation module 370 prepares a horizontal position designation command for one selected ink color based on the dot data for the toning white image. The horizontal position designation command is a command for designating the start position of the image that follows the horizontal direction (X direction) for one ink color when the toning white image is formed. The command preparation module 370 sets an appropriate image start position and prepares the horizontal position designation command with reference to the dot data for the toning white image for one ink color.

In step S690 (see FIG. 20), the command preparation module 370 (see FIG. 4) extracts dot data for one raster for one selected ink color from the dot data for the toning white image. In step S700, the command preparation module 370 searches for the ink code with reference to the ink code table ICT. The command preparation module 370 searches for the ink code for the white image in the ink code table ICT (see FIG. 22).

In step S710 (see FIG. 20), the command preparation module 370 (see FIG. 4) prepares the raster command (see FIG. 21B) based on the extracted dot data for one raster and the searched ink code. The processing from step S680 to step S710 of the command preparation processing is repeatedly performed until the processing of all ink colors used to form the toning white color is completed. That is, if there is any ink color that has not yet become a target to be processed (“No” in step S720), one ink color that has not become a target to be processed is selected, and the processing from step S680 to step S710 is performed with respect to the selected ink color. If the processing of the whole ink is completed (“Yes” in step S720), the preparation of raster commands corresponding to the respective ink colors used to form the toning which image is completed with respect to one raster of one partial region among the plurality of partial regions AW1 to Awn optionally determined from the print region.

The processing from step S680 to step S720 of the command preparation processing is repeatedly performed until the generation of the raster commands for the plurality or partial regions AW1 to Awn optionally determined from the print region is completed. That is, if there is any partial region that has not yet become a target to be processed (“No” in step S730), one partial region that has not become a target to be processed is selected, and the processing from step S680 to step S720 is performed based on the dot data for the toning white image.

The processing from step S620 to step S730 of the command preparation processing (see FIG. 20) is repeatedly performed until the processing of the whole raster of the print image PI is completed. That is, if there is any raster that has not yet become a target to be processed (“No” in step S740), the raster that has not become a target to be processed (raster that is lower than the raster to be processed) is selected, and the processing from step S620 to step S730 is performed with respect to the selected raster. If the processing of the whole raster is completed (“Yes” instep S740), the preparation of the commands corresponding to the ink colors used to form the color image and the white image is completed with respect to the whole raster.

In step S260 processed by the printer driver 300 as illustrated in FIG. 15, the printer driver 300 transmits the printing order designation command prepared in step S250, the vertical position designation command, the horizontal position designation command, and the raster command to the printer 100. Through the above-mentioned process, the processing by the printer driver 300 is completed.

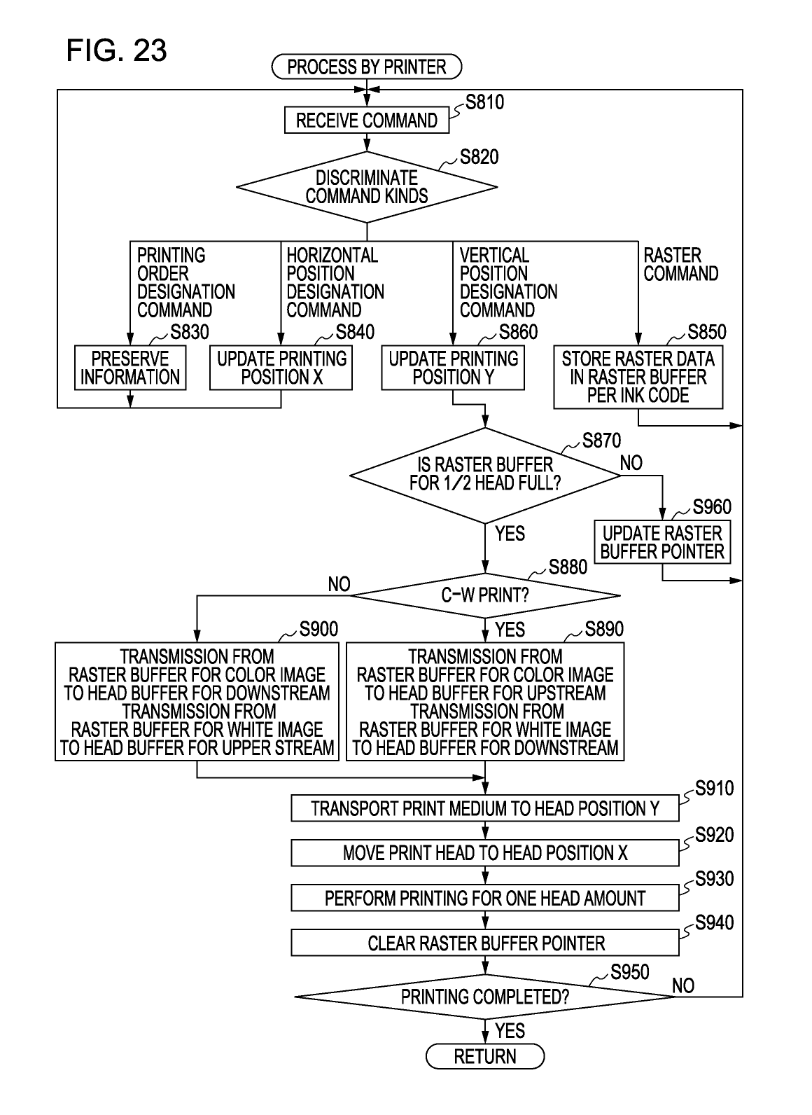

In step S130 of the printing process as illustrated in FIG. 6, the processing by the printer 100 is performed. FIG. 23 is a flowchart illustrating a flow of processing by the printer 100. In step S810, the CPU 110 (see FIG. 3) that executes the command processing module 112 (see FIG. 5) of the printer 100 receives a command transmitted from the printer driver 300 of the PC 200. The CPU 110 discriminates the kind of the received command (step S820), and performs the processing according to the kind of the command. If the received command is the printing order designation command, the CPU 110 preserves information for indicating the printing order designated by the printing order designation command in the RAM 130 (step S830), while if the received command is the horizontal position designation command, the CPU 110 updates the print start position X in the horizontal direction (step S840).

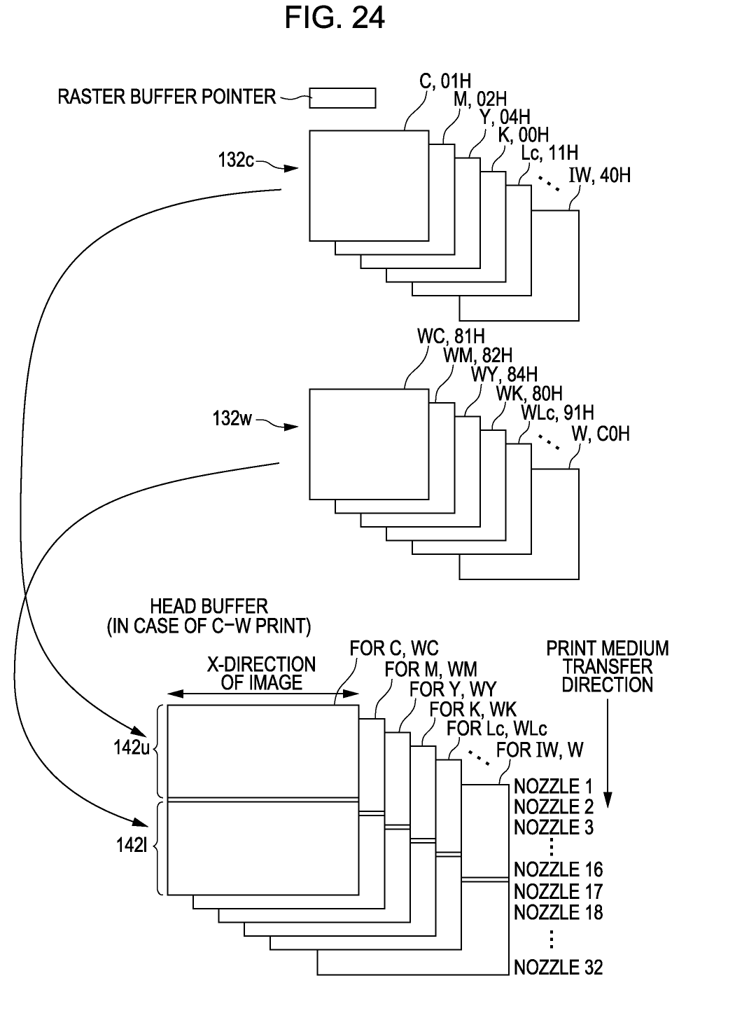

Also, the CPU 110 (see FIG. 3) that executes the command processing module 112 (see FIG. 5) stores the raster data (dot data) that is included in the raster command in a rater buffer 132 (see FIG. 5) per ink code if the received command is the raster command (step S850). FIG. 24 is an explanatory view illustrating the detailed configuration of a raster buffer and a head buffer. A raster buffer 132c for the color image appears in an upper portion of FIG. 24, and a raster buffer 132w for the white image appears in the middle of FIG. 24. As illustrated in FIG. 24, the raster buffer 132 is allocated with regions by ink codes (see FIG. 22). That is, the raster buffer 132c for the color image is composed of a set of regions that correspond to ink codes for the color image, respectively, and the raster buffer 132w for the white image is composed of a set of regions that correspond to ink codes for the white image, respectively. The size in X direction of each region of the raster buffer 132 corresponds to the image size, and the size in Y direction is equal to or larger than ½ of the height of the print head 144. The raster buffer 132 has a raster buffer pointer in Y direction that indicates what extend the raster data has been received to.

In a lower portion of FIG. 24, a head buffer 142 (see FIG. 5) appears. As illustrated in FIG. 24, the head buffer 142 is allocated with regions for 7 ink colors. That is, the head buffer 142 is composed of a set of a cyan (C and WC) region, a magenta (M and WM) region, a yellow (Y and WY) region, a black (K and WK) region, a light cyan (Lc and WLc) region, a light magenta (Lm and WLm) region, and a white (IW and W) region. The size in X direction of the head buffer 142 corresponds to the scanning distance of a carriage, and the size in Y direction corresponds to the number of nozzles that constitute a nozzle line 146 of the print head 144. Also, the regions by ink colors of the head buffer 142 are divided into an upstream head buffer 142u and a downstream head buffer 1421.

FIGS. 25A to 25C are explanatory views illustrating the construction of the print head 144 of the printer 100. As illustrated in FIGS. 25A and 25B, the print head 144 has nozzle lines 146 installed therein to correspond to 7 ink colors. The nozzle lines 146 are formed to extend in Y direction (transfer direction of the print medium). Also, as illustrated in FIG. 25C, each nozzle line 146 is composed of nozzle groups having 32 nozzles standing in a row along the transfer direction of the print medium. Among the nozzle groups constituting the nozzle line 146, a nozzle group that is composed of an upstream half of nozzles (first to 16th nozzles) positioned along the transfer direction of the print medium is called an upstream nozzle group, and a nozzle group that is composed of a downstream half of nozzles (17th to 32nd nozzles) positioned along the transfer direction of the print medium is called a downstream nozzle group.

As illustrated in FIG. 25A, in the case of W-C printing, the white image is formed using the upstream nozzle group of each nozzle line 146 of the print head 144, and the color image is formed using the downstream nozzle group. Also, as illustrated in FIG. 25B, in the case of C-W printing, the color image is formed using the upstream nozzle group of each nozzle line 146 of the print head 144, and the white image is formed using the downstream nozzle group. In this embodiment of the invention, in the case of W-C printing, the upstream nozzle group of each nozzle line 146 of the print head 144 corresponds to a second image forming unit in the present invention, and the downstream nozzle group corresponds to a first image forming unit in the present invention. By contrast, in the case of C-W printing, the upstream nozzle group of each nozzle line 146 of the print head 144 corresponds to the first image forming unit in the present invention, and the downstream nozzle group corresponds to the second image forming unit in the present invention.

As illustrated in FIG. 24, the upstream head buffer 142u is a head buffer 142 that corresponds to the upstream portion (the upstream nozzle group) along the transfer direction of the print medium of the print head 144, and the downstream head buffer 1421 is a head buffer 142 that corresponds to the downstream portion (the downstream nozzle group) along the transfer direction of the print medium of the print head 144.

In step S850 of FIG. 23, the CPU 110 (see FIG. 3) stores raster data in a position that is designated by the raster buffer pointer of the raster buffer 132 corresponding to the ink code with reference to the ink code included in the received raster command. Accordingly, the CPU 110 can distribute the raster data to appropriate rater buffers 132 without recognizing which of the color image and the white image the raster command is for.

The CPU 110 (see FIG. 3) that executes the command processing module 112 (see FIG. 5) updates the print start position Y in the vertical direction if the received command is a vertical position designation command (step S860). Then, the CPU 110 determines whether the raster buffer 132 that corresponds to ½ of the height of the print head 144 (see FIG. 5) is full (that is, if the raster data is stored) (step S870). If it is determined that the raster buffer is not full (step S870), the CPU 110 updates the raster buffer pointer of the raster buffer 132 (step S880).

If the raster data are stored in the raster buffer 132 that corresponds to ½ of the height of the print head 144 through repetition of the above-described processing, it is determined that the raster buffer 132 that corresponds to ½ of the height of the print head 144 is full (“Yes” in step S870). At this time, the CPU 110 (see FIG. 3) determines whether the printing order corresponds to C-W printing or W-C printing based on information that indicates the printing order preserved in the RAM 130 (step S880). If it is determined that the printing order corresponds to the C-W printing (“Yes” in step S880), the CPU 110 transmits the raster data from the raster buffer 132c for the color image to the upstream head buffer 142u (see FIG. 5), and transmits the raster data from the raster buffer 132w for the white image to the downstream head buffer 1421 (see FIG. 5) (step S890). FIG. 24 shows that in the case where the printing order corresponds to the C-W printing, the raster data is transmitted from the rater buffer 132c for the color image to the upstream head buffer 142u and the raster data is transmitted from the raster buffer 132w for the white image to the downstream head buffer 1421. Accordingly, the color image is formed using the upstream nozzle group of each nozzle line 146 of the print head 144, and the C-W printing (see FIG. 25B) for forming the white image using the downstream nozzle group is prepared.

On the other hand, if it is determined that the printing order corresponds to the W-C printing (“No” in step S880), the CPU 110 transmits the raster data from the raster buffer 132c for the color image to the downstream head buffer 1421 (see FIG. 5), and transmits the raster data from the raster buffer 132w for the white image to the upstream head buffer 142u (step S900). Accordingly, the white image is formed using the upstream nozzle group of each nozzle line 146 of the print head 144, and the W-C printing (see FIG. 25A) for forming the color image using the downstream nozzle group is prepared.

Next, the CPU 110 (see FIG. 3) transports (sub-scans) the print medium PM up to the head position Y by controlling a print medium transfer controller 160 and a print medium transfer motor 162 (step S910), and moves the print head 144 up to the print start position X by controlling a CR controller 150 and a CR motor 152 (step S920). Further, the CPU 110 performs the printing for the amount corresponding to the height of the print head 144 by performing main scanning (step S930). At this time, in the case of W-C printing (see FIG. 25A), the forming of the white image by the upstream nozzle group (see FIG. 25C) of the nozzle line 146 of the print head 144 and the forming of the color image by the downstream nozzle group are simultaneously performed. Also, in the case of C-W printing (see FIG. 25B), the forming of the color image by the upstream nozzle group of the nozzle line 146 of the print head 144 and the forming of the white image by the downstream nozzle group are simultaneously performed.

Then, the CPU 110 (see FIG. 3) clears the raster buffer pointer of the raster buffer 132 (step S940), and determines whether the printing of the whole print image PI is completed (step S950). The CPU 110 repeatedly performs the processing from step S810 to step S940 until it is determined that the printing process is completed. If it is determined that the printing process is completed, the printing process (see FIG. 6) is ended.

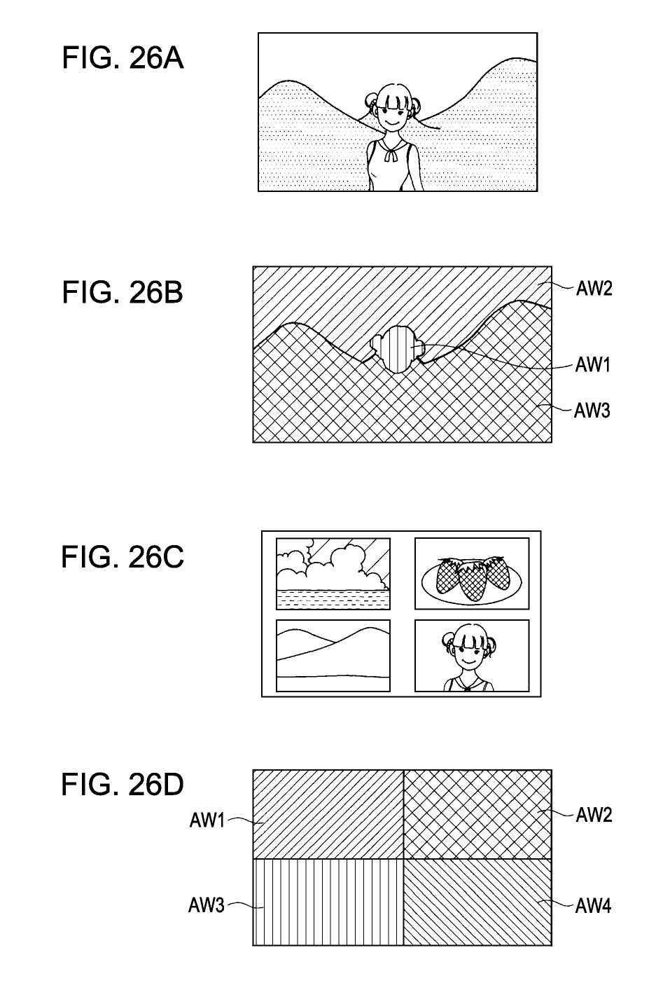

FIGS. 26A to 26D are explanatory views illustrating the effects of the printing system 10 according to an embodiment of the invention. FIG. 26A shows an example of a color image formed on the print medium PM, and FIG. 26B shows an example of a white image formed on the print medium PM. FIG. 26C shows another example of the color image formed on the print medium PM, and FIG. 26D shows another example of the white image formed on the print medium PM. In this embodiment, as illustrated in FIGS. 26B and 26D, the printing system 10 divides the print region into the plurality of partial regions AW1 to AW3 as illustrated in FIG. 26B, divides the print region into the plurality of partial regions AW1 to AW4 as illustrated in FIG. 26D, and designates at least one set of the toning white density value (T value) and the color specification value (LAB value) with respect to the plurality of partial regions. Specifically, for example, a set of the same toning white density value and color specification value (a set of T value and LAB value) may be designated with respect to the partial regions AW1 to AW3 of FIG. 26B, or a set of the different toning white density value and color specification value (a set of T value and LAB value) may be designated with respect to the partial regions AW1 to AW3. Accordingly, with respect to the plurality of partial regions on the print region, a toning white image (white image) of a desired color may be formed together with the color image.

Also, in performing the printing process in the printing system 10 according to the embodiment of the invention, the characteristic color for characterizing the color image is determined based on the data of the color image (color image data Cdata) that is formed on the print region, and the color of the toning white image (that is, the T value and the LAB value of the toning white) is determined based on the corresponding characteristic color. Accordingly, by combining the colors of the toning white image and the color image, it becomes possible to perform the printing using diverse color expressions. For example, in the above-described embodiment, if the toning white image is set to be the complementary color of the characteristic color of the color image, it is possible to perform the printing with an improved contrast ratio of the color image through combination of the colors of the toning white image and the color image. Specifically, for example, in the case of FIGS. 26A and 26B, it is possible to perform the printing with the blue color of a sky portion of the color image emphasized by setting the LAB value and the T value for forming the toning white image presenting a yellow-orange that is the complementary color of blue in the partial region AW2 that corresponds to the sky portion of the color image. In the same manner, it is possible to perform the printing with the color image emphasized by setting the LAB value and the T value for forming the complementary color of the skin color (yellow-orange) in the partial region AW1 that corresponds to a face portion of a person in the color image and forming the complementary color of bluish green in the partial region AW3 that corresponds to a mountain portion.

Also, the characteristic color of the color image may be determined, for example, based on pixel values obtained by sampling the color image data Cdata. By doing this, for example, the characteristic color of the color image can be determined even in the case where additional information (for example, Exif information and so on) is not attached to the color image data Cdata. That is, the characteristic color of the color image can be determined in a general-purpose method.

Also, the characteristic color of the color image may be determined by at least either the discrimination of a photographed scene of the image data or the extraction of a predetermined object included in the image data. By doing this, the characteristic color of the color image can be easily determined with reference to the additional information (for example, Exif information or the like) that is added to the color image data Cdata in advance. Specifically, for example, in the case of FIGS. 26C and 26D, it becomes possible to perform the printing with the color image emphasized by setting the LAB value and the T value for forming the toning white image presenting yellow-orange that is the complementary color of blue in the partial region AW1 that corresponds to “photographed scene=sea” in the color image. Further, if it is assumed that the characteristic color of the color image is determined by the extraction of a predetermined object (for example, the extraction of the face region) that is included in the image data, it becomes possible to automatically perform the detection of the partial region that corresponds to the face portion of a person in the color image (specifically, the detection of the partial region AW1 in FIG. 26B.

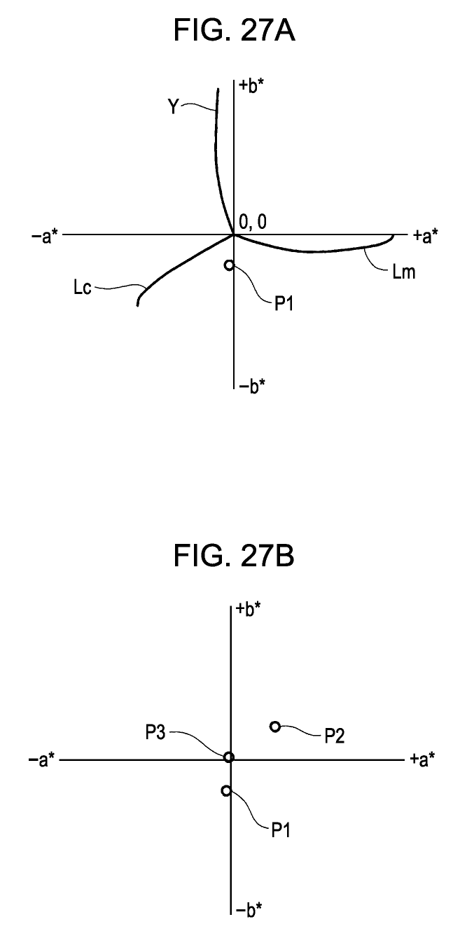

FIGS. 27A and 27B are explanatory views illustrating the concept of white toning for adjusting a white color. FIG. 27A shows an example of a point P1 of a color of a white ink of the printer 100 in an a*-b* plane, and FIG. 27B shows an example of a position P2 of a white color of a target and a position P3 of a color which is obtained by mixing a predetermined amount of yellow ink with the white ink of the printer 100. As illustrated in FIG. 27B, for example, by mixing yellow ink with the white ink of the printer 100, the color of the white image can be closer to the white color of the target. Also, for example, by mixing a predetermined amount of light magenta ink with the white ink, the color of the white image can be much closer to the white color of the target. As described above, by using the white ink and at least one color ink except for the white color when the white image is formed, the color of the white image can be changed to a desired color.

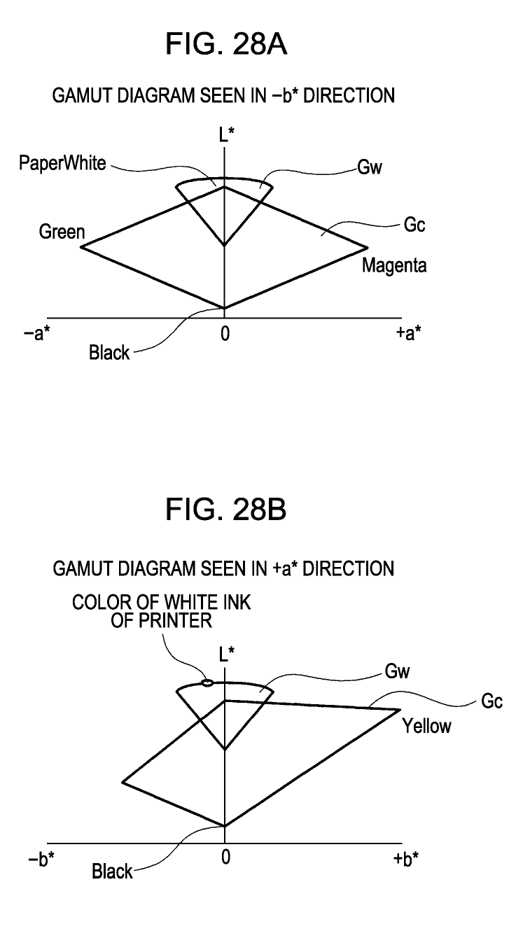

FIGS. 28A and 28B are explanatory views illustrating an example of color representation regions (gamut) of a color image and a white image. FIG. 28A shows the gamut Gc of the color image and the gamut Gw of the toning white image as seen from −b* direction, and FIG. 28B shows the gamut Gc of the color image and the gamut Gw of the toning white image as seen from +a* direction. In this embodiment of the invention, in forming the color image, one (first image forming unit) of the upstream nozzle group and the downstream nozzle group of the nozzle line 146 of the print head 144 is used. Also, in forming the color image, 6 color inks (first ink group) except for the white ink among 7 color inks are used, and the white ink is not used. On the other hand, in forming the white image, the other (second image forming unit) of the upstream nozzle group and the downstream nozzle group of the nozzle line 146 of the print head 144 is used. Also, in forming the toning white image among the white image, 5 color inks (second ink group) of white, yellow, black, light cyan, and light magenta among 7 color inks are used, and two color inks of cyan and magenta are not used. Since the color representation region of the first ink group and the color representation region of the second ink group are different from each other, the gamut Gc (first color representation region) of the color image and the gamut Gw (second color representation region) of the toning white image are also different from each other. In this embodiment, in performing the printing process by the printing system 10, two images (the color image and the toning white image) having different color representation regions can be formed on the printing medium PM, and thus diverse prints including a plurality of images having different color representation regions can be easily prepared. Also, in performing the printing process by the printing system 10, the forming of the color image and the forming of the toning white image are simultaneously performed in at least a portion of a period of printing, and thus diverse prints including a plurality of images having different color representation regions can be efficiently and easily prepared.

Also, in performing the printing process by the printing system 10 according to this embodiment of the invention, in the case of either the W-C printing or the C-W printing, it is possible to simultaneously perform the forming of the white image using one of the upstream nozzle group and the downstream nozzle group and the forming of the color image using the other of the upstream nozzle group and the downstream nozzle group in the same main scanning (same pass). Accordingly, instead of forming the whole of one side of the white image and the color image on the print medium and then forming the whole of the other side of the white image and the color image on the print medium, the color image and the white image can be formed on the print medium through a printing process only once, and the color of the toning white image can be changed to a desired color.

In performing the printing process by the printing system 10 according to this embodiment of the invention, the printer 100 receives a printing order designation command (see FIG. 21A) for designating the printing order from the PC 200. If the printing order in which the color image is first formed is designated, the printer 100 sets the upstream nozzle group as a nozzle group that is used to form the color image and sets the downstream nozzle group as a nozzle group that is used to form the white image. If the printing order in which the white image is first formed is designated, the printer 100 sets the upstream nozzle group as a nozzle group that is used to form the white image and sets the downstream nozzle group as a nozzle group that is used to form the color image. Accordingly, in performing the printing process by the printing system 10 according to this embodiment of the invention, even in the case of the C-W printing or the W-C printing, the color of the toning white image can be changed to a desired color, and thus the printing system can cope with wide use specification of the prints (see FIG. 8).

Also, in the printing system 10 according to this embodiment of the invention, the ink code that is included in the raster command (see FIG. 21B) as the print command is set to uniformly cope with the 7 color inks and combinations of the color image and the white image. Accordingly, the CPU 110 of the printer 100 can control the nozzle group (the upstream nozzle group or the downstream nozzle group) that is used to form the color image based on the raster command that includes the ink code corresponding to the color image, and control the nozzle group (the downstream nozzle group or the upstream nozzle group) that is used to form the white image based on the raster command that includes the ink code corresponding to the white image, without recognizing which of the color image and the white image the raster command is for.

Also, in the printing system 10 according to this embodiment of the invention, the raster buffer 132 of the printer 100 includes the color image region 132c and the white image region 132w (see FIG. 5). Accordingly, in the CPU 110 of the printer 100, the raster buffer 132 stores the raster data included in the raster command that includes the ink code corresponding to the color image in the color image region 132c, and stores the raster data included in the raster command that includes the ink code corresponding to the white image in the white image region 132w, so that the CPU 110 of the printer 100 can control the nozzle group used to form the color image and the nozzle group used to form the white image.

Also, in performing the printing process according to the printing system 10 according to this embodiment of the invention, 4 color inks of yellow (Y), black (K), light cyan (Lc), and light magenta (Lm) among 6 color inks except for white are used to form the toning white image, but two color inks of cyan (c) and magenta (M) are not used. That is, in forming the toning white image, the dark color ink among two kinds of inks of the light color ink and the dark color ink for the same color is not used. Accordingly, in performing the printing process according to this embodiment of the invention, the deterioration of the picture quality (the increase of the granularity) in the toning white image can be suppressed as the color of the toning white image is changed to a desired color. Also, in performing the printing process according to this embodiment of the invention, a block (K) ink is used to form the toning white image, and thus the adjustment of the brightness of the toning white image becomes possible to extend the selectable range of the color of the toning white image.

Also, in performing the printing process according to the printing system 10 according to this embodiment of the invention, a plurality of optional partial regions on the print region can be selected in the region designation window AS1. Also, for optional partial region selected by the user (user selection region), the toning white (the color of the toning white image) can be designated. Since the designation of the toning white is performed using the toning white designation window EW1, the color of the toning white image can be accurately and easily designated when the color image and the white image are printed using a plurality of inks including white. Also, the user can conveniently obtain a recommended value of the toning white (the color of the toning white image) based on the results of analyzing the color image data Cdata by using the automatic toning white designation processing (the process that is performed by pressing the auto button Ab2 of the region designation window AS1).

### B. Second Embodiment

In the first embodiment, it is exemplified that at least one set of the density value (T value) of the toning white and the color specification value (LAB value) is designated with respect to the plurality of partial regions optionally designated from the print region. By contrast, in the second embodiment, the print region is not divided, but is considered as one partial region. In this state, the characteristic color of the print medium is acquired, and the density value (T value) of the toning white and the color specification value (LAB value) based on the corresponding characteristic color are designated. Hereinafter, only the configuration and operation which are not different from those of the first embodiment will be described.

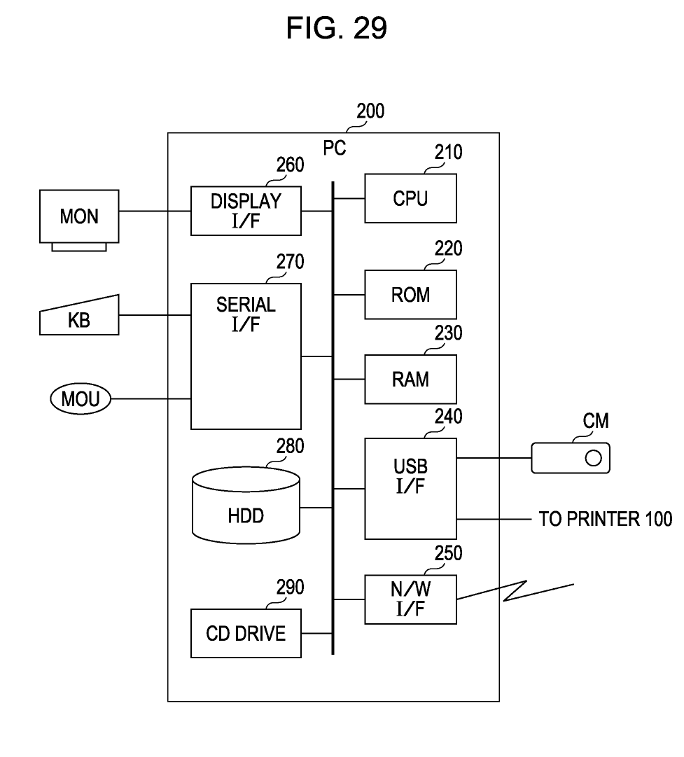

FIG. 29 is an explanatory view schematically illustrating the configuration of a PC 200 according to a second embodiment of the invention. The second embodiment is different from the first embodiment as illustrated in FIG. 2 on the point that a color measurement device CM that corresponds to the USB interface is connected to the USB interface 240 of the PC 200, and other configuration is the same as that of the first embodiment.

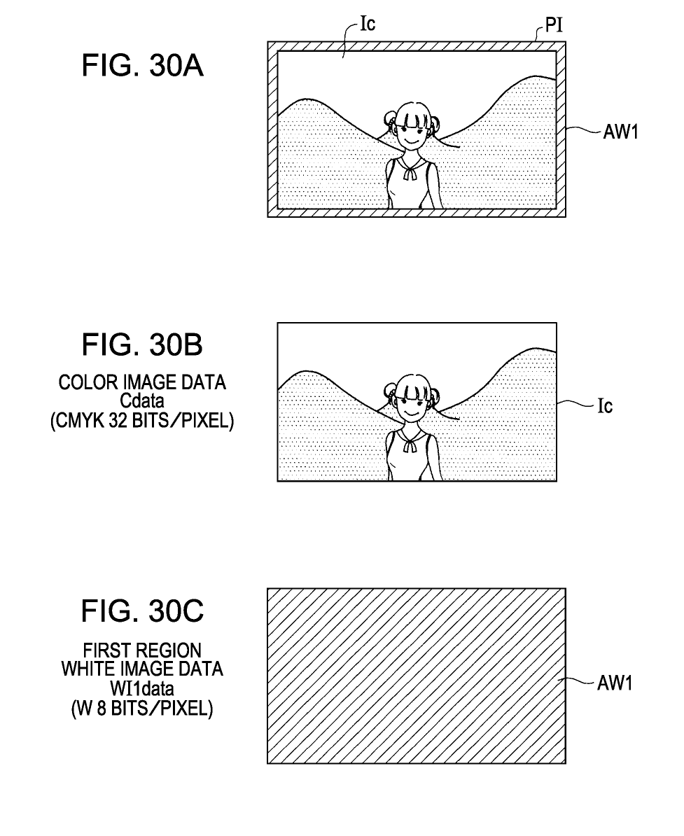

FIGS. 30A to 30C are explanatory views illustrating an example of a print image PI, color image data Cdata, and white image data WINdata per region according to the second embodiment. The second embodiment is different from the first embodiment as illustrated in FIGS. 7A to 7E on the point that the white region (a region corresponding to a white image, that is, a region in which the white image is to be formed when printing is performed) is formed only by the first partial region AW1 having the size corresponding to the print region, and other configuration is the same as that of the first embodiment. In the second embodiment, since the white region is formed only by the first partial region AW1 having the size corresponding to the print region, the white image data WINdata per region and the first region white image data WI1data have the same meaning. Although it is exemplified, for convenience in explanation, that the white region has the size that corresponds to the print region, the size of the first partial region AW1 that forms the white region may be different from that of the print region.

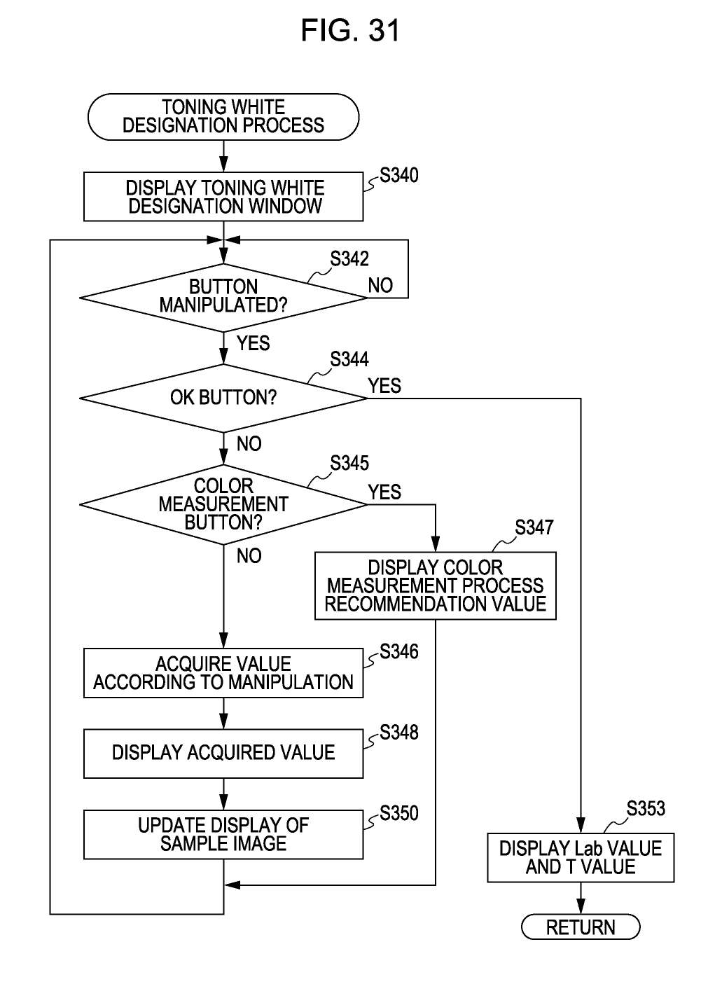

FIG. 31 is a flowchart illustrating a flow of the toning white designation process by the application program AP according to the second embodiment of the invention. In the second embodiment, the toning white designation processing as explained with reference to FIG. 9 is not performed, but the region toning white designation processing as explained with reference to FIG. 11 is performed as the “toning white designation processing”. This is, in the second embodiment, to perform no designation of the partial regions in the white region. In performing the toning white designation processing, the second embodiment is different from the first embodiment of the invention as illustrated in FIG. 11 on the point that steps S345 and S347 are added, and step S353 is performed instead of step S352.

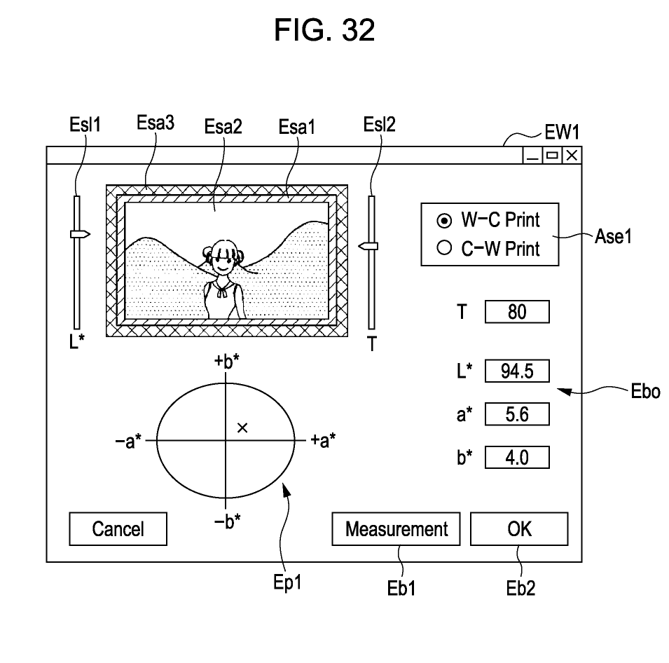

FIG. 32 is an explanatory view illustrating an example of the toning white designation window according to the second embodiment of the invention. The second embodiment is different from the first embodiment as illustrated in FIG. 12A on the point that a color image display area Esa2, a medium color display area Esa3, a printing order designation section Ase1, and a measurement button Eb1 are further included.

The color image display area Esa2 is a region that is a little smaller than the designation region display area Esa1, and is installed to surround the designation region display area Esa1. On the other hand, the medium color display area Esa3 is a little larger than the designation region display area Esa1, and is installed to surround the designation region display area Esa1. In the designation region display area Esa1, the first partial region (white region) AW1 having the size corresponding to the print region is displayed. In the color image display area Esa2, the color image is displayed. In the medium color display area Esa3, a background that imitates the print medium, specifically, a background having the color of the print medium that is acquired by the color measurement processing to be described later, is displayed. The white region of the designation region display area Esa1 and the color image of the color image display area Esa2 are layer-displayed, respectively. The white region and the layer of the color image are set to have a predetermined transparency. It is preferable that this predetermined transparency is determined after consideration of the permeability and so on when the printing is actually performed. In this case, the transparency of the layer may be configured to be changeable. The printing order designation section Ase1 is a designation unit for designating the printing order (see FIGS. 8A and 8B) as illustrated in FIG. 10 of the first embodiment. The measurement button Eb1 is a button for performing the color measurement process to be described later.

In step S345 of FIG. 31, the toning white designation module 420 determines whether the measurement button Eb1 is pressed. If the measurement button Eb1 is pressed (“Yes” in step S345), the analysis module 430 performs the color measurement processing in step S347. Specifically, the analysis module 430 reads the result of color measurement by the color measurement device CM (see FIG. 29). The analysis module 430 displays the color obtained from the read result of color measurement through the toning white designation module 420 on the medium color display area Esa3 as the color of the print medium PM. Then, the analysis module 430 determines the color obtained from the read result of color measurement as the characteristic color of the print medium PM, and sets the LAB value and the T value for forming the toning white image having a color that is the complementary color of the characteristic color of the print medium PM. The toning white designation module 420 displays the LAB value and the T value as the value in the value input box Ebo, positions of the slider bars Esl1 and Esl2, the position of “X” in the ab-plane display area Ep1, and the color of the designated region display area Esa1, and the processing is shifted to step S342. Also, in step S352, the toning white designation module 420 preserves the LAB value and the T value of the first partial region (white region) AW1.

As described above, even in the second embodiment of the invention, the toning white image (white image) of a desired color can be formed together with the color image. Further, in the second embodiment of the invention, when the printing is performed using a plurality of color inks including white, the characteristic color that characterizes the print medium is acquired, and the color of the toning white image (that is, the T value and the LAB value of the toning white) is determined based on the characteristic color of the print medium. Accordingly, on the print region, the toning white image (white image) having the color based on the color of the print medium can be formed.

### C. Third Embodiment

In the third embodiment, in the region toning white designation processing according to the first embodiment, it is possible to set the toning white based on the characteristic color that characterizes the print medium. Hereinafter, only the configuration and operation which are not different from those of the first embodiment will be described.

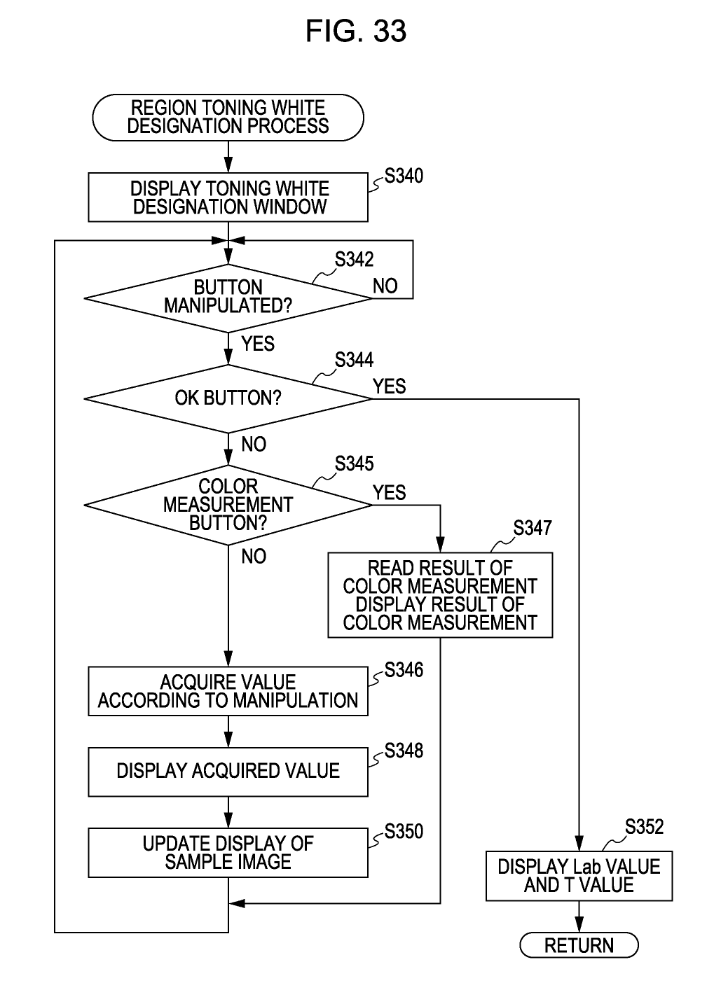

FIG. 33 is a flowchart illustrating a flow of the region toning white designation process by the application program AP according to the third embodiment of the invention. The third embodiment is different from the first embodiment as illustrated in FIG. 11 on the point that steps S345 and S347 are added.

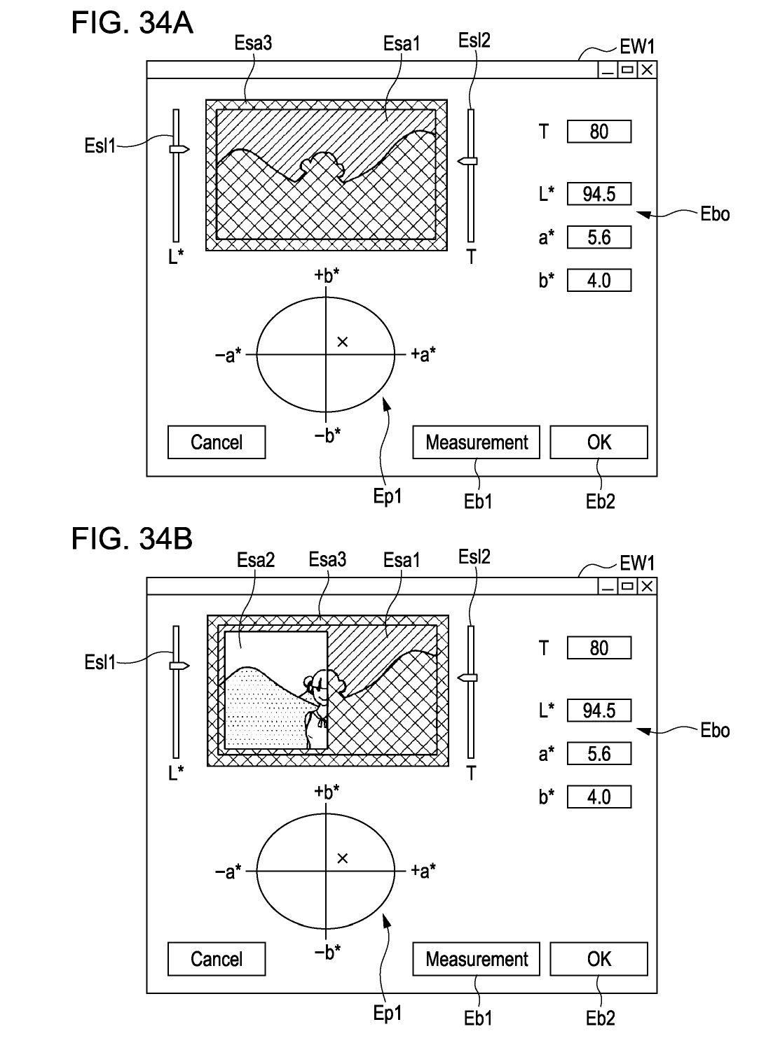

FIGS. 34A and 34B are explanatory views illustrating an example of a toning white designation window according to the third embodiment of the invention. FIG. 34A shows an example of the toning white designation window EW1, and FIG. 34B shows another example of the toning white designation window EW1. The third embodiment as illustrated in FIGS. 34A and 34B is different from the first embodiment as illustrated in FIGS. 12A and 12B on the point that a medium color display area Esa3 and a measurement button Eb1 is further included.

The medium color display area Esa3 is a little larger than the designation region display area Esa1, and is installed to surround the designation region display area Esa1. In the medium color display area Esa3, a background imitating the print medium, specifically, a background having the color of the print medium that is acquired by a color measurement process to be described later, is displayed. The white region of the designation region display area Esa1 is layer-displayed, and the layer is set to have a predetermined transparency. It is preferable that this predetermined transparency is determined after consideration of the permeability and so on when the printing is actually performed. In this case, the transparency of the layer may be configured to be changeable. The measurement button Eb1 is a button for performing the color measurement process to be described later.

The processing in steps S345 and S347 of FIG. 33 is the same as the color measurement processing (steps S345 and S347 in FIG. 31) as described in the second embodiment of the invention.

As described above, even in the third embodiment of the invention, a plurality of partial regions are designated on the print region, and the toning white image (white image) of a desired color can be formed together with the color image with respect to the plurality of partial regions. Further, in the third embodiment of the invention, with reference to the characteristic color of the data of the color image (color image data Cdata) formed on the print region and the characteristic color of the print medium, the color of the toning white image (that is, the T value and the LAB value of the toning white) can be determined based on either of the characteristic colors or in consideration of both the characteristic colors. Accordingly, the user convenience can be improved.

### D. Modified Embodiments

The invention is not limited to the above described embodiments or examples, and may be embodied in diverse aspects without departing from the scope of the invention. For example, the following modifications are possible.

### D1. Modified Example 1

In the embodiments of the invention as described above, it is exemplified that the analysis module 430 determines the LAB value and the T value for forming the toning white image so that the color of the toning white image becomes the complementary color of the characteristic color of the color image data Cdata. However, it is sufficient if the analysis module 430 sets the LAB value and the T value for forming the toning white image based on the characteristic color of the color image data Cdata, and a color except for the complementary color may be used. For example, the analysis module 430 may be so configured that a user can set the color tone of the toning white image for the characteristic image.

Also, in the embodiments of the invention as described above, it is exemplified that all regions on the print region are white region (regions corresponding to the white image, that is, regions on which the white image is to be formed during printing). However, the white region may be a partial region on the print region.

Also, in the embodiments of the invention as described above, the relationship between the white region and the region in which the color image is to be formed is exemplified. However, the white region is a set of partial regions that can be optionally designated from the print region. Due to this, for example, a partial region that overlaps only a portion of the color image can be designated as the white region. It is also possible to designate the partial region that does not overlap the color image as the white region. Further, the size of the white region is optional, for example, the white region may be smaller than the region occupied by the color image.

Also, in the embodiments of the invention as described above, it is exemplified that the white color is adjusted (white toning) by mixing a plurality of color inks with the white ink with respect to all partial regions. However, it is also possible to install a partial region where the white toning is not performed. Further, in the toning white designation window EW1, the T value and the LAB value that indicate “atonal color” may be displayed as default values.

In the second embodiment of the invention, it is exemplified that the color of the print medium PM is acquired using the color measurement device CM. However, the color measurement device CM may not be used. For example, a user may select the color of the print medium PM.

In the second embodiment of the invention, it is exemplified that the automatic toning white designation processing (see FIG. 13) is not performed. However, in the second embodiment of the invention, the automatic toning white designation processing may be performed. Specifically, for example, by pressing the auto button after installing the auto button in the toning white designation window EW1 as described with reference to FIG. 32, the analysis module 430 analyzes the color image data. The analysis module 430 determines the characteristic image of the color image data according to the result of analysis, and sets the T value and the LAB value so that the color of the toning white image becomes the complementary color of the characteristic color. In this case, in analyzing the color image data, as described in the first embodiment, sampling of the color image data, scene discrimination, and the like may be used.

In the second embodiment, it is exemplified that the print region is not divided, and is considered as one partial region. However, even in the second embodiment, the print region can be divided into a plurality of partial regions. Specifically, for example, the color of the print medium PM may be acquired using the color measurement device CM (or by user's designation) for the respective partial regions after the plurality of partial regions are designated in the print region. By doing this, for example, even in the case where the print medium PM is a medium that does not have a uniform color, the color of an appropriate toning white image (that is, the T value and the LAB value of the toning white) can be determined based on the color of the print medium.

### D2. Modified Example 2

In the embodiments of the invention, the configuration of the printing system 10 is merely exemplary, and can be modified in diverse manners. For example, although it is exemplified that the printer 100 performs the printing using 7 color inks of cyan, magenta, yellow, black, light cyan, light magenta, and white in the respective embodiments of the invention, it is sufficient if the printer 100 is a printer that performs the printing using a plurality of inks including white. For example, the printer 100 may be a printer that performs the printing using 5 color inks of cyan, magenta, yellow, black, and white.

Also, in the embodiments of the invention, it is exemplified that the color image is formed using 6 color inks except for white, and the white ink is not used. However, the ink colors used to form the color image may be optionally settable in accordance with the usable ink colors of the printer 100. For example, a white ink may be used to form the color image.

Also, in the embodiments of the invention, it is exemplified that in forming the toning white image, 5 color inks of white, yellow, black, light cyan, and light magenta are used, and two color inks of cyan and magenta are not used. However, it is sufficient if the ink colors used to form the toning white image may include white and at least one color except for the white, and the ink colors can be optionally set in accordance with the usable ink colors of the printer 100. For example, in forming the toning white image, only 4 color inks of white, yellow, light cyan, and light magenta may be used, or 7 color inks of white, yellow, black, light cyan, light magenta, cyan, and magenta may be used.

Also, in the embodiments of the invention, it is exemplified that the printer 100 is a printer that performs the printing as reciprocating (main-scanning) the carriage on which the print head 144 is mounted. However, the present invention can also be applied to the printing process by a line printer that does not accompany the reciprocating carriage.

Also, in the embodiments of the invention, it is exemplified that the white image processing unit 400 is included in the application program AP. However, the configuration according to the embodiments of the invention is merely exemplary, and the white image processing unit 400 may adopt optional features. For example, the white image processing unit 400 may be included in the print driver 300.

Also, in the embodiments of the invention, it is exemplified that the printer driver 300 is included in the PC 200 and the printer 100 receives a command from the printer driver 300 of the PC 200 to perform the printing (see FIG. 4). However, the printer 100 may have the same function as the printer driver 300 that includes the white image processing unit 400. Also, the printer 100 may further have the same function as the application program AP.

Also, in the embodiments of the invention, it is exemplified that the processing that converts the raster data (dot data) into a data type to be transmitted to the print head 144 (see FIG. 5) is performed by the printer 100. However, the same processing may be performed by the printer driver 300. In this case, the printer 100 may not have the raster buffer 132.

Also, in the embodiments of the invention, the contents of the lookup table LUTw (see FIG. 17) for the toning white image or the lookup table LUTc (see FIG. 19) for the color image are merely exemplary, and such contents may be experimentally set in advance in accordance with the composition of the inks used in the printer 100. Also, such contents may be diversely modified in accordance with the contents of data (used color space) output from the application program AP or ink colors used in the printer 100. In the same manner, the color conversion processing using tables or the contents of the ink color separation processing can be diversely modified.

Also, in the embodiments of the invention, it is exemplified that the halftone processing module 320 for the color image or the halftone processing module 360 for the toning white image (see FIG. 4) performs the halftone processing with reference to the dither pattern. However, the halftone processing may be performed by another method called an error diffusion method. Also, in the case where the printer 100 can form the dots having different sizes with respect to the respective ink colors, multiple-level dithering for determining the ON/OFF of the dots and the dot size rather than binarization for determining the ON/OFF of the dots may be performed through the halftone processing.

Also, in the embodiments of the invention, the configuration of the printing order designation command or raster command (see FIG. 21) and the contents of the ink code table ICT (see FIG. 22) are merely exemplary, and various modifications thereof are possible. In the embodiments of the invention, the ink code uniformly copes with a plurality of color inks and combinations of the color image and the white image. However, it is not necessary to set the ink code as described above. If the ink code is set as described above, the CPU 110 of the printer 100 can performs the processing of the command in accordance with the ink code included in the raster command without recognizing which of the color image and the white image the raster command is for.

Also, in the embodiments of the invention, a part of the configuration implemented by hardware may be replaced by software, or a part of the configuration implemented by software may be replaced by hardware.

In the case where a part or the whole part of functions is implemented by software, the software (or a computer program) may be provided in the form stored in a computer readable recording medium. In the invention, the computer readable recording medium is not limited to portable recording medium such as a flexible disk or CD-ROM, and may include an internal storage device in a computer such as various kinds of RAM or ROM, and an external storage device fixed to a computer such as hard disk or the like.

### D3. Modified Example 3

In the embodiments of the invention, it is exemplified that the color image and the white image are simultaneously formed on the transparent film as the print medium PM, and the prints on which the color image and the white image are formed are prepared. However, the print medium PM used for the printing process is not limited to the transparent film, but an arbitrary medium, such as a semi-transparent film, paper, cloth, or the like, may be selected. In this case, if the transparent film is used as the print medium PM, the color image Ic may be formed to keep its external appearance even in the case of C-W printing (see FIG. 8B).

Also, in the embodiments of the invention, the printer 100 can perform the printing process that forms only the color image (including the color image that is formed using the white color), and in this case, the printing is performed using the whole nozzle line 146 without dividing the nozzle line 146 (see FIG. 25) into the upstream group and the downstream group of the print head 144). That is, in performing the printing process that forms the color image and the white image, the printer 100 may divide the nozzle line 146 into the nozzle group for forming the color image and the nozzle group for forming the white image to perform the printing.

### D4. Modified Example 4

In the embodiments of the invention, the display contents of the region designation window AS1 (see FIG. 10) and the toning white designation window EW1 (see FIGS. 12, 32, and 34) are merely exemplary, and may be diversely modified. For example, in the embodiments of the invention, it is exemplified that in the UI window W1 for designating the toning white, the toning white is designated by the color specification value in the L*a*b* color system (color space). However, the toning white may be designated by another color system (for example, RGB, L*u*v*, or the like). Also, it is exemplified that in the toning white designation window EW1, the density of the toning white is designated by the T value. However, the designation of the T value may be omitted.

What is claimed is:

1. A print control apparatus which controls a printing apparatus that performs printing using a plurality of color inks including a white ink, the print control apparatus comprising:
a toning white designation unit that designates a plurality of partial regions in a print region where the printing by the printing apparatus is performed, and designating at least one of sets of density values and color specification values with respect to a toning white that is defined by a combination of the density value and the color specification value in a predetermined color system with respect to the plurality of partial regions; and
a print control unit that controls a first image forming unit that forms a color image on the print region and a second image forming unit that forms a toning white image on the partial regions in which the sets of the density values and the color specification values are designated.

2. The print control apparatus according to claim 1, further comprising an analysis unit which determines characteristic colors that characterize the color image based on image data that is data of the color image formed on the print region, and sets at least either of the density value and the color specification value based on the characteristic colors of the color image.

3. The print control apparatus according to claim 2, wherein the analysis unit further sets at least either of the density value and the color specification value so that the toning white becomes a complementary color of the characteristic color of the color image.

4. The print control apparatus according to claim 2, wherein the analysis unit further determines the characteristic color of the color image based on a pixel value that is obtained by sampling the image data.

5. The print control apparatus according to claim 2, wherein the analysis unit further determines the characteristic color of the color image by at least either the discrimination of a photographed scene of the image data or the extraction of a predetermined object included in the image data.

6. The print control apparatus according to claim 1, wherein the print control unit further controls the first image forming unit and the second image forming unit so that the image forming by the first image forming unit and the image forming by the second image forming unit are simultaneously performed in at least a portion of a period of printing.

7. The print control apparatus according to claim 1, wherein the analysis unit further acquires the characteristic color of the print medium, and sets at least either the density value or the color specification value based on the characteristic color of the print medium.

8. A method of controlling a printing apparatus that performs printing using a plurality of color inks including a white ink, the method comprising the steps of:
(a) designating a plurality of partial regions in a print region where the printing by the printing apparatus is performed, and designating at least one of sets of density values and color specification values with respect to a toning white that is defined by a combination of the density value and the color specification value in a predetermined color system with respect to the plurality of partial regions;
(b) forming a color image on the print region; and
(c) forming a toning white image on the partial regions in which the sets of the density values and the color specification values are designated.
